(19) United States
(12) Patent Application Publication
(10) Pub. No.: US 2026/0081160 A1
(43) Pub. Date: Mar. 19, 2026

(54) FAST-CHARGING OF HYBRID LITHIUM-ION/LITHIUM-METAL ANODES BY NANOSTRUCTURED HARD CARBON FLOWER HOST

(71) Applicant: The Board of Trustees of the Leland Stanford Junior University, Stanford, CA (US)

(72) Inventors: Huaxin Gong, Stanford, CA (US); Yuelang Chen, Stanford, CA (US); Yi Cui, Stanford, CA (US); Zhenan Bao, Stanford, CA (US)

(73) Assignee: The Board of Trustees of the Leland Stanford Junior University, Stanford, CA (US)

(21) Appl. No.: 19/109,935

(22) PCT Filed: Sep. 8, 2023
(86) PCT No.: PCT/US2023/073747

§ 371 Date: Mar. 7, 2025

Related U.S. Application Data
(60) Provisional application No. 63/405,319, filed on Sep. 9, 2022.

(51) Int. Cl. H01M 4/587; H01M 4/04; H01M 4/66

(52) U.S. Cl. CPC H01M 4/587; H01M 4/0404; H01M 4/0409; H01M 4/661

(57) ABSTRACT

The present embodiments relate generally to stable cycling of metallic lithium under high current densities and realistic cell conditions based on a flower-like nanostructured hard carbon host (CF). In embodiments, CF is both intercalated with lithium ions and plated with lithium metal to render a hybrid lithium-ion/lithium-metal anode capacity. The hybrid cells showed >99% CE up to 12 mA/cm² (4 mAh/cm²) and >99.5% CE up to 16 mA/cm² (2.5 mAh/cm²) with commercial carbonate electrolyte. The stability of the hybrid anodes was attributed to uniform lithium plating morphology and fast ion diffusion pathways enabled by the open-pore nanostructures of CF. Moreover, the CF∥NMC811 hybrid cells (2 mAh/cm²) showed excellent performance (˜70% capacity retention after 200 cycles, 100% SOC, room temperature) at 10 mA/cm² current densities (<20 min charging for 100% SOC), while demonstrating ˜4 times anode specific capacity and much better cyclic stability compared to graphite]|NMC lithium-ion cells at such current.

### CROSS-REFERENCE TO RELATED APPLICATIONS

The present application claims priority to U.S. Provisional Patent Application No. 63/405,319 filed Sep. 9, 2022, the contents of which are incorporated herein by reference in their entirety.

### STATEMENT OF GOVERNMENT SPONSORED RESEARCH

This invention was made with Government support under contract DE-AC02-7600515 awarded by the Department of Energy. The Government has certain rights in the invention.

### TECHNICAL FIELD

The present embodiments relate generally to battery anode material, battery anodes, battery cells, battery additives, electric vehicles and consumer electronics.

### BACKGROUND

Lithium metal could provide ˜10 times the theoretical specific capacity compared to graphite. However, despite recent progress in improving the coulombic efficiency (CE), metallic lithium still suffers from poor cyclic stability at high current densities, which limits applications of lithium metal anode in high-power scenarios.

It is against this technological backdrop that the present Applicant sought a technological solution to these and other problems rooted in this technology.

### SUMMARY

The present embodiments relate generally to stable cycling of metallic lithium under high current densities and realistic cell conditions based on a flower-like nanostructured hard carbon host (CF). In embodiments, CF is both intercalated with lithium ions and plated with lithium metal to render a hybrid lithium-ion/lithium-metal anode capacity. The hybrid cells showed >99% CE up to 12 mA/cm² (4 mAh/cm²) and >99.5% CE up to 16 mA/cm² (2.5 mAh/cm²) with commercial carbonate electrolyte. The stability of the hybrid anodes was attributed to uniform lithium plating morphology and fast ion diffusion pathways enabled by the open-pore nanostructures of CF. Moreover, the CF∥NMC811 hybrid cells (2 mAh/cm²) showed excellent performance (˜70% capacity retention after 200 cycles, 100% SOC, room temperature) at 10 mA/cm² current densities (<20 min charging for 100% SOC), while demonstrating ˜4 times anode specific capacity and much better cyclic stability compared to graphite∥NMC lithium-ion cells at such current.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1(a) to 1(h) illustrate example aspects of embodiments.

FIGS. 2(a) and 2(b)(i) to 2(b)(v) illustrate additional example aspects of embodiments.

FIGS. 3(a) to 3(j) illustrate additional example aspects of embodiments.

FIGS. 4(a) to 4(g) illustrate further example aspects of embodiments.

FIGS. 5(a) to 5(f) illustrate example performance aspects of embodiments.

FIG. 6 is a TEM image showing the hard carbon structures of CF according to embodiments.

FIGS. 7(a) to 7(e) illustrate example morphology evolution of CF during lithiation and delithiation according to embodiments.

FIGS. 8(a) to 8(c) illustrate an example comparison of Li∥CF and Li∥Cu cells according to embodiments: (a) An SEM image of 1 mAh/cm² Li deposited on Cu foil. (b) Voltage profiles of Li∥Cu cells at different current densities. (c) Rate performances of Li∥CF and Li∥Cu cells. Cycling conditions: ˜1 mAh/cm², ˜1.4 mg/cm² CF, the charging current began at 1 mA/cm² and was ramped up 1 mA/cm² every 5 cycles till it reached 10 mA/cm², discharging current: 1 mA/cm², electrolyte: LP40:FEC=10:1. CF cells are precycled between 0-1.6 V for 5 cycles to passivate the surface.

FIGS. 9(a) to 9(d) illustrate example morphology of CF and CS electrode after lithiation at high current (12 mA/cm²) according to embodiments.

FIGS. 10(a) and 10(b) provide post-mortem SEM images of CF particles after rinsing according to embodiments. Cycling conditions: 700 mAh/g, ˜2.5 mAh/cm2, 1-20 mA/cm2, 1 mA/cm2 increase every 5 cycles, fully stripped to 1.6 V at 100th cycle. Electrolyte: LP57:FEC=10:1. Surface of electrode was rinsed by DEC solvent to remove rSEI.

FIGS. 11(a) to 11(c) provide post-mortem SEM images of the cross-section of an unrinsed CF electrode according to embodiments. Cycling conditions: 700 mAh/g, ˜2.5 mAh/cm2, 1-20 mA/cm2, 1 mA/cm2 increase every 5 cycles, fully stripped to 1.6 V at 100th cycle. Electrolyte: LP57:FEC=10:1. Surface of electrode was unrinsed to preserve rSEI.

FIGS. 12(a) to 12(c) illustrate example rSEI structures on CF particles according to embodiments. Cycling conditions: 700 mAh/g, ˜2.5 mAh/cm², 1-20 mA/cm², 1 mA/cm² increase every 5 cycles, fully stripped to 1.6 V at 100th cycle. Electrolyte: LP57:FEC=10:1.

FIGS. 13(a) to 13(d) illustrate example morphology of CF electrode at different specific capacity (mAh per gram of CF) according to embodiments. At a low specific capacity, lithium was confined within the pores on individual CF particles. When specific capacity was increased, lithium started to form chunks and fill the space between CF particles. Finally, lithium chunks covered the CF electrode surfaces upon further increase of specific capacity. Cycling conditions: 0.5 mAh/cm², 1 mAh/cm² and 10 mAh/cm², CF areal loading: 0.38 mg/cm², 1 mA/cm², Electrolyte: LP40:FEC=10:1.

FIGS. 14(a) to 14(c) illustrate example effects of specific capacity on the performances of CF according to embodiments. Cycling conditions: 700 mAh/g and 2600 mAh/g, ˜4 mAh/cm², charging current: 1-15 mA/cm², 1 mA/cm² increase every 5 cycles, discharging current: 1 mA/cm². Electrolyte: LP57:FEC=10:1.

FIGS. 15(a) to 15(c) illustrate example voltage and current of PITT and example effects of areal capacity on the rate performances of CF according to embodiments.

FIGS. 16(a) to 16(c) illustrate example effects of electrolyte on the rate performances of CF and example voltage and current profiles of CF electrodes precycling in Li∥CF cells before assembling CF∥NMC811 cells.

FIG. 17 illustrates an example current profile of CF∥NMC811 cells.

FIGS. 18(a) and 18(b) illustrate example Voltage profiles of full cells at 1 mA/cm² charging current and 1 mA/cm² discharging current.

FIGS. 19(a) and 19(b) illustrate example Voltage profiles of full cells at 10 mA/cm² charging current and 1 mA/cm² discharging current.

FIGS. 20(a) and 20(b) illustrate example Voltage profiles of full cells at 10 mA/cm² charging current and 10 mA/cm² discharging current.

FIG. 21 illustrates example Long term cycling data of CF∥NMC811 cells.

FIG. 22 illustrates an example single layer CF∥NMC811 pouch cell cycling performance.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

### Introduction

The increasing need for clean energy has brought tremendous attention to rechargeable batteries. Among numerous battery chemistries, metallic lithium is regarded as the “holy grail” of the anode chemistry due to its high specific capacity (3860 mAh/g), which is more than 10 times of graphite (372 mAh/g) in lithium-ion batteries (LIBs). However, the intrinsic reactivity of lithium metal causes poor cyclic stability and safety concerns, making it challenging to commercialize lithium metal batteries (LMBs). (Lin, D.; Liu, Y.; Cui, Y. Reviving the Lithium Metal Anode for High-Energy Batteries. Nature Nanotech 2017, 12 (3), 194-206. https://doi.org/10.1038/nnano.2017.16).

Through years of development, LMBs have gained significant progress regarding stability improvement via strategies such as the design of electrolyte (Yu, Z.; Wang, H.; Kong, X.; Huang, W.; Tsao, Y.; Mackanic, D. G.; Wang, K.; Wang, X.; Huang, W.; Choudhury, S.; Zheng, Y.; Amanchukwu, C. V.; Hung, S. T.; Ma, Y.; Lomeli, E. G.; Qin, J.; Cui, Y.; Bao, Z. Molecular Design for Electrolyte Solvents Enabling Energy-Dense and Long-Cycling Lithium Metal Batteries. Nat Energy 2020, 5 (7), 526-533. https://doi.org/10.1038s41560-020-0634-5; Chen, Y.; Yu, Z.; Rudnicki, P.; Gong, H.; Huang, Z.; Kim, S. C.; Lai, J.-C.; Kong, X.; Qin, J.; Cui, Y.; Bao, Z. Steric Effect Tuned Ion Solvation Enabling Stable Cycling of High-Voltage Lithium Metal Battery. J. Am. Chem. Soc. 2021, 143 (44), 18703-18713. https://doi.org/10.1021/jacs.1c09006; Yu, Z.; Rudnicki, P. E.; Zhang, Z.; Huang, Z.; Celik, H.; Oyakhire, S. T.; Chen, Y.; Kong, X.; Kim, S. C.; Xiao, X.; Wang, H.; Zheng, Y.; Kamat, G. A.; Kim, M. S.; Bent, S. F.; Qin, J.; Cui, Y.; Bao, Z. Rational Solvent Molecule Tuning for High-Performance Lithium Metal Battery Electrolytes. Nat Energy 2022, 7 (1), 94-106. https://doi.org/10.1038/s41560-021-00962-y; Cao, X.; Ren, X.; Zou, L.; Engelhard, M. H.; Huang, W.; Wang, H.; Matthews, B. E.; Lee, H.; Niu, C.; Arey, B. W.; Cui, Y.; Wang, C.; Xiao, J.; Liu, J.; Xu, W.; Zhang, J.-G. Monolithic Solid-Electrolyte Interphases Formed in Fluorinated Orthoformate-Based Electrolytes Minimize Li Depletion and Pulverization. Nat Energy 2019, 4 (9), 796-805. https://doi.org/10.1038/s41560-019-0464-5; Niu, C.; Liu, D.; Lochala, J. A.; Anderson, C. S.; Cao, X.; Gross, M. E.; Xu, W.; Zhang, J.-G.; Whittingham, M. S.; Xiao, J.; Liu, J. Balancing Interfacial Reactions to Achieve Long Cycle Life in High-Energy Lithium Metal Batteries. Nat Energy 2021, 6 (7), 723-732. https://doi.org/10.1038/s41560-021-00852-3; Kim, M. S.; Zhang, Z.; Rudnicki, P. E.; Yu, Z.; Wang, J.; Wang, H.; Oyakhire, S. T.; Chen, Y.; Kim, S. C.; Zhang, W.; Boyle, D. T.; Kong, X.; Xu, R.; Huang, Z.; Huang, W.; Bent, S. F.; Wang, L.-W.; Qin, J.; Bao, Z.; Cui, Y. Suspension Electrolyte with Modified Li+ Solvation Environment for Lithium Metal Batteries. Nat. Mater. 2022, 21 (4), 445-454. https://doi.org/10.1038/s41563-021-01172-723-3; Weber, R.; Genovese, M.; Louli, A. J.; Hames, S.; Martin, C.; Hill, I. G.; Dahn, J. R. Long Cycle Life and Dendrite-Free Lithium Morphology in Anode-Free Lithium Pouch Cells Enabled by a Dual-Salt Liquid Electrolyte. Nat Energy 2019, 4 (8), 683-689. https://doi.org/10.1038/s41560-019-0428-9; Zhang, W.; Lu, Y.; Wan, L.; Zhou, P.; Xia, Y.; Yan, S.; Chen, X.; Zhou, H.; Dong, H.; Liu, K. Engineering a Passivating Electric Double Layer for High Performance Lithium Metal Batteries. Nat Commun 2022, 13 (1), 2029. https://doi.org/10.1038/s41467-022-29761-z), coating (Zheng, G.; Wang, C.; Pei, A.; Lopez, J.; Shi, F.; Chen, Z.; Sendek, A. D.; Lee, H.-W.; Lu, Z.; Schneider, H.; Safont-Sempere, M. M.; Chu, S.; Bao, Z.; Cui, Y. High-Performance Lithium Metal Negative Electrode with a Soft and Flowable Polymer Coating. ACS Energy Lett. 2016, 1 (6), 1247-1255. https://doi.org/10.1021/acsenergylett.6b00456; Liu, K.; Pei, A.; Lee, H. R.; Kong, B.; Liu, N.; Lin, D.; Liu, Y.; Liu, C.; Hsu, P.; Bao, Z.; Cui, Y. Lithium Metal Anodes with an Adaptive “Solid-Liquid” Interfacial Protective Layer. J. Am. Chem. Soc. 2017, 139 (13), 4815-4820. https://doi.org/10.1021/jacs.6b13314; Huang, Z.; Choudhury, S.; Gong, H.; Cui, Y.; Bao, Z. A Cation-Tethered Flowable Polymeric Interface for Enabling Stable Deposition of Metallic Lithium. J. Am. Chem. Soc. 2020, 142 (51), 21393-21403. https://doi.org/10.1021/jacs.0c09649; Fu, C.; Venturi, V.; Kim, J.; Ahmad, Z.; Ells, A. W.; Viswanathan, V.; Helms, B. A. Universal Chemomechanical Design Rules for Solid-Ion Conductors to Prevent Dendrite Formation in Lithium Metal Batteries. Nat. Mater. 2020, 19 (7), 758-766. https://doi.org/10.1038/s41563-020-0655-2), and host (Ke, X.; Cheng. Y.; Liu, J.; Liu, L.; Wang, N.; Liu, J.; Zhi, C.; Shi, Z.; Guo, Z. Hierarchically Bicontinuous Porous Copper as Advanced 3D Skeleton for Stable Lithium Storage. ACS Appl. Mater. Interfaces 2018, 10 (16), 13552-13561. https://doi.org/10.1021/acsami.8b01978; Liu, H.; Yue, X.; Xing, X.; Yan, Q.; Huang, J.; Petrova, V.; Zhou, H.; Liu, P. A Scalable 3D Lithium Metal Anode. Energy Storage Materials 2019, 16, 505-511. https://doi.org/10.1016/j.ensm.2018.09.021; Xie, J.; Ye, J.; Pan, F.; Sun, X.; Ni, K.; Yuan, H.; Wang, X.; Shu, N.; Chen, C.; Zhu, Y. Incorporating Flexibility into Stiffness: Self-Grown Carbon Nanotubes in Melamine Sponges Enable A Lithium-Metal-Anode Capacity of 15 MA h Cm⁻² Cyclable at 15 MA Cm⁻². Adv. Mater. 2018, 1805654. https://doi.org/101.002/adma.201805654; Niu C.; Pan, H.; Xu, W.; Xiao, J.; Zhang, J.-G.; Luo, L.; Wang, C.; Mei, D.; Meng, J.; Wang, X.; Liu, Z.; Mai, L.; Liu, J. Self-Smoothing Anode for Achieving High-Energy Lithium Metal Batteries under Realistic Conditions. Nat. Nanotechnol. 2019, 14 (6), 594-601. https://doi.org/10.038/s41565-019-0427-9; Lin, D.; Liu, Y.; Liang, Z.; Lee, H.-W.; Sun, J.; Wang, H.; Yan, K.; Xie, J.; Cui, Y. Layered Reduced Graphene Oxide with Nanoscale Interlayer Gaps as a Stable Host for Lithium Metal Anodes. Nature Nanotech 2016, 11 (7), 626-632. https://doi.org/10.1038/nnano.2016.32; Yan, K.; Lu, Z.; Lee, H.-W.; Xiong, F.; Hsu, P.-C.; Li, Y.; Zhao, J.; Chu, S.; Cui, Y. Selective Deposition and Stable Encapsulation of Lithium through Heterogeneous Seeded Growth. Nat Energy 2016, 1 (3), 16010. https://doi.org/10.1038/nenergy.2016.10; Chi, S.-S.; Liu, Y.; Song, W.-L.; Fan, L.-Z.; Zhang, Q. Prestoring Lithium into Stable 3D Nickel Foam Host as Dendrite-Free Lithium Metal Anode. Adv. Funct. Mater. 2017, 27 (24), 1700348. https://doi.org/10.1002/adfm.201700348). The coulombic efficiency (CE) of LMBs has significantly improved over the last decade. Currently, the state-of-art LMBs could achieve a >99.5% CE and an 80% capacity retention over hundreds of cycles. However, most of those were achieved at low current densities (<1 mA/cm²). For a typical industrial electrode loading (2-6 mAh/cm²), such low current densities would require an extremely long charging time (2 to 6 hours), which is undesirable for high-power demanding applications such as electric vehicles (EVs). (Ahmed, S.; Bloom, I.; Jansen, A. N.; Tanim, T.; Dufek, E. J.; Pesaran, A.; Burnham, A.; Carlson, R. B.; Dias, F.; Hardy, K.; Keyser, M.; Kreuzer, C.; Markel, A.; Meintz, A.; Michelbacher, C.; Mohanpurkar, M.; Nelson, P. A.; Robertson, D. C.; Scoffield, D.; Shirk, M.; Stephens, T.; Vijayagopal, R.; Zhang, J. Enabling Fast Charging-A Battery Technology Gap Assessment. Journal of Power Sources 2017, 367, 250-262. https://doi.org/10.1016/j.jpowsour.2017.06.055; Weiss, M.; Ruess, R.; Kasnatscheew, J.; Levartovsky, Y.; Levy, N. R.; Minnmann, P.; Stolz, L.; Waldmann, T.; Wohlfahrt-Mehrens, M.; Aurbach, D.; Winter, M.; Ein-Eli, Y.; Janek, J. Fast Charging of Lithium-Ion Batteries: A Review of Materials Aspects. Advanced Energy Materials 2021, 11 (33), 2101126. https://doi.org/10.1002/aenm.202101126.) For LMBs to become competitive with LIBs, the fast-charging capability is important and deserves attention.

Currently, fast-charging LMBs remain underexplored. Fast charging requires high rates of ion transport within electrodes, electrolytes and their interfaces, which are challenging to achieve simultaneously with stable lithium metal chemistry. (Aurbach, D. A Short Review of Failure Mechanisms of Lithium Metal and Lithiated Graphite Anodes in Liquid Electrolyte Solutions. Solid State Ionics 2002, 148 (3-4), 405-416. https://doi.org/10.1016/S0167-2738(02)0008-2; López, C. M.; Vaughey, J. T.; Dees, D. W. Insights into the Role of Interphasial Morphology on the Electrochemical Performance of Lithium Electrodes. J. Electrochem. Soc. 2012, 159 (6), A873-A886. https://doi.org/10.1149/2.100206jes; Lu, D.; Shao, Y.; Lozano, T.; Bennett, W. D.; Graff, G. L.; Polzin, B.; Zhang, J.; Engelhard, M. H.; Saenz, N. T.; Henderson, W. A.; Bhattacharya, P.; Liu, J.; Xiao, J. Failure Mechanism for Fast-Charged Lithium Metal Batteries with Liquid Electrolytes. Adv. Energy Mater. 2015, 5 (3), 1400993. https://doi.org/10.1002/aenm.201400993; Jiao, S.; Zheng, J.; Li, Q.; Li, X.; Engelhard, M. H.; Cao, R.; Zhang, J.-G.; Xu, W. Behavior of Lithium Metal Anodes under Various Capacity Utilization and High Current Density in Lithium Metal Batteries. Joule 2018, 2 (1), 110-124. https://doi.org/10.16/j.joule.2017.10.007; Liu, Y.; Xu, X.; Sadd, M.; Kapitanova, O. O.; Krivchenko, V. A.; Ban, J.; Wang, J.; Jiao, X.; Song, Z.; Song, J.; Xiong, S.; Matic, A. Insight into the Critical Role of Exchange Current Density on Electrodeposition Behavior of Lithium Metal. Adv. Sci. 2021, 8 (5), 2003301. https://doi.org/10.1002/advs.202003301) One of the strategies to address such a problem is to use 3D conductive materials to host lithium metal. (Fan, L.; Zhuang, H. L.; Zhang, W.; Fu, Y.; Liao, Z.; Lu, Y. Stable Lithium Electrodeposition at Ultra-High Current Densities Enabled by 3D PMF/Li Composite Anode. Adv. Energy Mater. 2018, 8 (15), 1703360. https://doi.org/10.1002/aenm.201703360; Ye, L.; Liao, M.; Cheng, X.; Zhou, X.; Zhao, Y.; Yang, Y.; Tang, C.; Sun, H.; Gao, Y.; Wang, B.; Peng, H. Lithium-Metal Anodes Working at 60 MA Cm⁻² and 60 MAh Cm⁻² through Nanoscale Lithium-Ion Adsorbing. Angew. Chem. Int. Ed. 2021, 60 (32), 17419-17425. https://doi.org/10.1002/anie.202106047.)

Since porous materials could increase the contact area of lithium metal with the current collector and electrolyte, local current density could be decreased to alleviate unstable filament growth and residue SEI (rSEI) accumulation. In addition, low-tortuosity hosts/current collectors have shown promising abilities to stablize lithium metal at high current densities (Chen, H.; Pei, A.; Wan, J.; Lin, D.; Vili, R.; Wang, H.; Mackanic, D.; Steinruck, H.-G.; Huang, W.; Li, Y.; Yang, A.; Xie, J.; Wu, Y.; Wang, H.; Cui, Y. Tortuosity Effects in Lithium-Metal Host Anodes. Joule 2020, 4 (4), 938-952. https.//doi.org/10.1016/j.joule.2020.03.008), which was attributed to the shortened lithium-ion diffusion pathways. Even so, the improvement of LMBs' performances by 3D hosts is still limited, and testing conditions of fast-charging hosts are usually far from realistic battery conditions, including high cathode loading (>2 mAh/cm²) and limited excess host capacity/high anode specific capacity (>700 mAh/g).

According to certain aspects, the present embodiments relate to stable cycling of Li metal under realistic full cell conditions by plating lithium on a unique open-pore hard carbon flower (CF) host. With a negative to positive (N/P) ratio much lower than 1 (only counting interchelation capacity), lithium metal was intentionally plated on nanostructured CF particles in addition to the initial lithium-ion intercalation. The anode capacity (700 mAh/g) consists of a 30%-40% contribution from lithium-ion intercalation and a 60-70% contribution from lithium metal plating. Lithium metal was observed to be uniformly plated on the nanostructures and demonstrated >99.5% CE at up to 16 mA/cm² (equal to 6.4 C) at a 2.5 mAh/cm² loading with commercial carbonate electrolyte and a fluoroethylene carbonate (FEC) additive. When paired with commercial NMC811 electrodes (2 mAh/cm², charged to 4.4V) and without extra lithium on the anode, the cells showed excellent cyclic stability (˜70% retention for 200 cycles, 100% SOC, room temperature) at 10 mA/cm² charging current and various discharging currents. Considering the scalability of this novel open-pore hard carbon host and potential further development of appropriate pre-lithiation strategy, this anode material is promising for industrial applications. This work demonstrates that the combination of lithium-ion intercalation and nanostructured host design could significantly improve the efficiency and stability of lithium metal chemistry at high current densities.

### Characterizations of Open-Pore Carbon Flower Particles

To investigate the effect of nanostructures on lithium plating behavior, synthesized were two types of hard carbon particles: flower-like hard carbon particles (CF) and spherical hard carbon particles (CS). The synthesis procedures can be performed using known techniques (e.g. Chen, S.; Koshy, D. M.; Tsao, Y.; Pfattner, R.; Yan, X.; Feng, D.; Bao, Z. Highly Tunable and Facile Synthesis of Uniform Carbon Flower Particles. J. Am. Chem. Soc. 2018, 140 (32), 10297-10304. https://doi.org/10.1021/jacs.8b05825; Tsao, Y.; Gong, H.; Chen, S.; Chen, G.; Liu, Y.; Gao, T. Z.; Cui, Y.; Bao, Z. A Nickel-Decorated Carbon Flower/Sulfur Cathode for Lean-Electrolyte Lithium-Sulfur Batteries. Adv. Energy Mater. 2021, 2101449. https://doi.org/10.1002/aenm.202101449) and as discussed in more detail below.

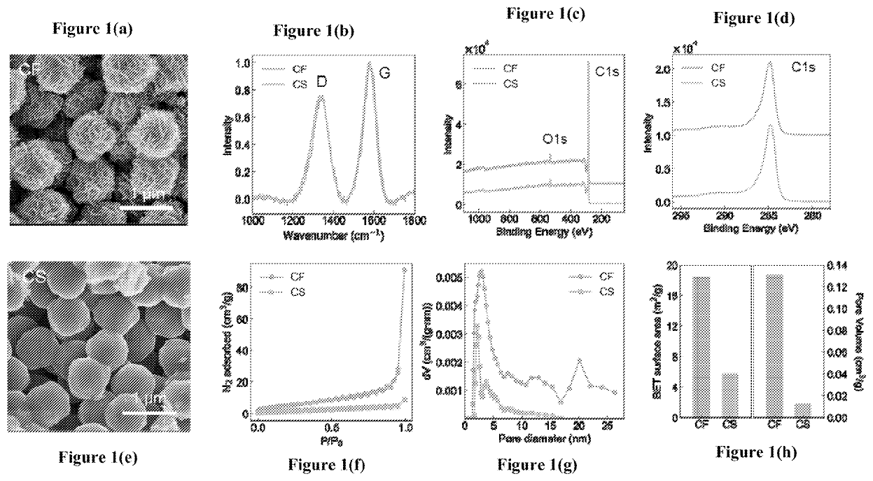

FIGS. 1(a) to 1(h) illustrate example synthesis results, wherein FIG. 1(a) is an SEM image of CF particles, FIG. 1(b) illustrates Raman spectra of CF and CS, FIG. 1(c) illustrates XPS survey spectra of CF and CS, FIG. 1(d) provides High-resolution CIs XPS spectra of CF and CS, FIG. 1(e) provides an SEM image of CS particles, FIG. 1(f) illustrates N₂ physisorption isotherm curves of CF and CS, FIG. 1(g) illustrates pore size distribution of CF and CS derived from isotherm curves and QSDFT calculation and FIG. 1(h) illustrate BET surface areas and pore volumes of CF and CS derived from isotherm curves.

More particularly, FIGS. 1(a) and 1(e) are SEM images of CF and CS, respectively. CF has an unique open-pore particle morphology. Such structures were reported to facilitate ion diffusion (Xu, Z.; Zhuang, X.; Yang, C.; Cao, J.; Yao, Z.; Tang, Y.; Jiang, J.; Wu, D.; Feng, X. Nitrogen-Doped Porous Carbon Superstructures Derived from Hierarchical Assembly of Polyimide Nanosheets. Adv. Mater. 2016, 28 (10), 1981-1987. https://doi.org/10.1002/adma.201505131), and it is expected to be beneficial in fast-charging scenarios. To show the similarity of chemical properties between those two materials, conducted were Raman spectroscopy and X-ray photoelectron spectroscopy (XPS) characterizations. FIG. 1(b) shows the Raman spectra of CF and CS. The overlapping D and G peaks indicate CF and CS have almost identical carbon structures (Ferrari, A. C.; Robertson, J. Resonant Raman Spectroscopy of Disordered, Amorphous, and Diamondlike Carbon. Phys. Rev. B 2001, 64 (7), 075414. https://doi.org/10.1103/PhysRevB.64.075414). Both surfaces of CF and CS contain mostly carbon (CF: 95.9 at %, CS: 96.1 at %) and small concentrations of oxygen (CF: 4.1 at %, CS: 3.9 at %), as shown by XPS survey scans (FIG. 1(c)). The similarity between the high-resolution C1s XPS peaks indicates similar chemical environments of carbon on the surface (FIG. 1(d)). However, the pore structures of CF and CS are different due to the existence of nanostructures on CF. CF showed a much higher N₂ adsorption volume compared to CF, especially at the high-pressure region, indicating CF has more mesopores and macropores (FIG. 1(f)). Pore size distribution derived from quenched solid density functional theory (QSDFT) calculation of N₂ isotherms also shows more mesopores in CF (FIG. 1(g)). Brunauer-Emmett-Teller (BET) surface area (18.5 m²/g) and pore volume (0.13 cm³/g) of CF are also higher compared to those of CS (5.8 m²/g and 0.01 cm³/g) (FIG. 1(h)).

### Study of Lithium Plating Behavior

First studied was lithium plating behavior on CF with Li∥CF half-cells. CF powders, conductive carbon black, and binder were mixed and coated on copper foils. Lithium foils were used as counter electrodes, and commercial carbonate electrolytes with fluoroethylene carbonate additives (LP40/LP57:FEC=10:1) were used to construct Li∥CF coin cells as described below.

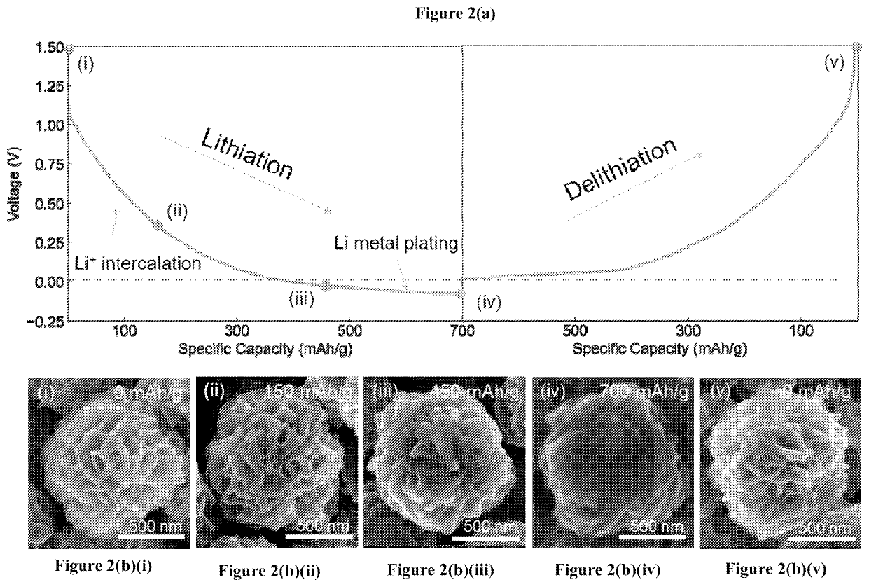

FIGS. 2(a) and 2(b) illustrate example aspects of this study: FIG. 2(a) illustrates aa typical charging and discharging voltage profile of CF. the points (i)-(v) in FIG. 2(a) represent five selected charging and discharging states for SEM morphology studies. The dashed line corresponds to 0 V v.s. Li. Capacity above the dashed line is contributed by lithium-ion intercalation. Capacity below the dashed line is contributed by lithium metal plating. FIG. 2(b) illustrates example morphology evolution of CF during charging and discharging. FIGS. 2(b)(i)-(v) correspond to the five points in (a). Cycling conditions: 2 mAh/cm², 2 mA/cm², electrolyte: LP57:FEC=10:1.

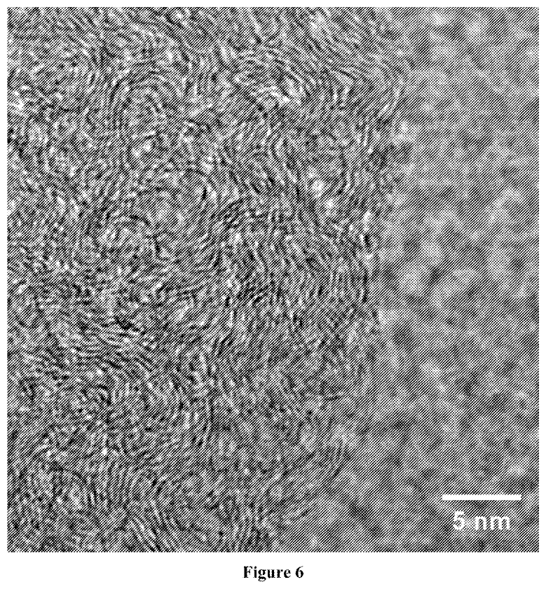

More particularly, a typical charging (lithiation) and discharging (delithiation) voltage profile is shown in FIG. 2(a). CF electrodes were lithiated with a controlled specific capacity (700 mAh/g). The specific capacity of CF has two major contributions: lithium-ion intercalation and lithium metal plating. When the local voltage is above 0 V (v.s. Li⁺/Li), lithium-ion intercalation is the dominant capacity contributor due to the hard carbon nature of CF (FIG. 6) (Zhang, B.; Ghimbeu, C. M.; Laberty, C.; Vix-Guterl, C.; Tarascon, J.-M. Correlation Between Microstructure and Na Storage Behavior in Hard Carbon. Adv. Energy Mater. 2016, 6 (1), 1501588. https://doi.org/10.1002/aenm.201501588). Further over-lithiation causes voltage to go below 0 V (v.s. Li⁺/Li), where lithium metal plating happens. This hybrid lithium-ion/lithium metal operation could significantly increase the specific capacity of the CF than mere lithium-ion intercalation. Similar hybrid anodes were previously reported by intentionally overlithiating graphite particles. (Sun, Y.; Zheng, G.; Seh, Z. W.; Liu, N.; Wang, S.; Sun, J.; Lee, H. R.; Cui, Y. Graphite-Encapsulated Li-Metal Hybrid Anodes for High-Capacity Li Batteries. Chem 2016, 1 (2), 287-297. https://doi.org/10.1016/j.chemper.2016.07.009; Martin, C.; Genovese, M.; Louli, A. J.; Weber, R.; Dahn, J. R. Cycling Lithium Metal on Graphite to Form Hybrid Lithium-Ion/Lithium Metal Cells. Joule 2020, 4 (6), 1296-1310. https://doi.org/10.1016/j.joule.2020.04.003; Cai, W.; Yan, C.; Yao, Y.; Xu, L.; Chen, X.; Huang, J.; Zhang, Q. The Boundary of Lithium Plating in Graphite Electrode for Safe Lithium-Ion Batteries. Angew. Chem. Int. Ed. 2021, 60 (23), 13007-13012. https://doi.org/10.1002/anie.202102593; Son, Y.; Lee, T.; Wen, B.; Ma, J.; Jo, C.; Cho, Y.-G.; Boies, A.; Cho, J.; De Volder, M. High Energy Density Anodes Using Hybrid Li Intercalation and Plating Mechanisms on Natural Graphite. Energy Environ. Sci. 2020, 13 (10), 3723-3731. https://doi.org/10.1039/D0EE02230F; Xie, C.; Chang, J.; Shang, J.; Wang, L.; Gao, Y.; Huang, Q.; Zheng, Z. Hybrid Lithium-Ion/Metal Electrodes Enable Long Cycle Stability and High Energy Density of Flexible Batteries. Adv Funct Materials 2022, 2203242. https://doi.org/10.1002/adfm.202203242.) Specific capacity of graphite could be improved by 50-100% with decent cyclic stability (80% capacity retention up to 150 cycles). However, due to the bulkiness of graphite, lithium filaments could easily grow on large graphite particles. The stable cycling of hybrid graphite electrodes also depends on special electrolyte designs such as dual salt electrolytes. Most importantly, stable cycling of the hybrid graphite electrode at high current densities with the presence of lithium metal has not been demonstrated so far.

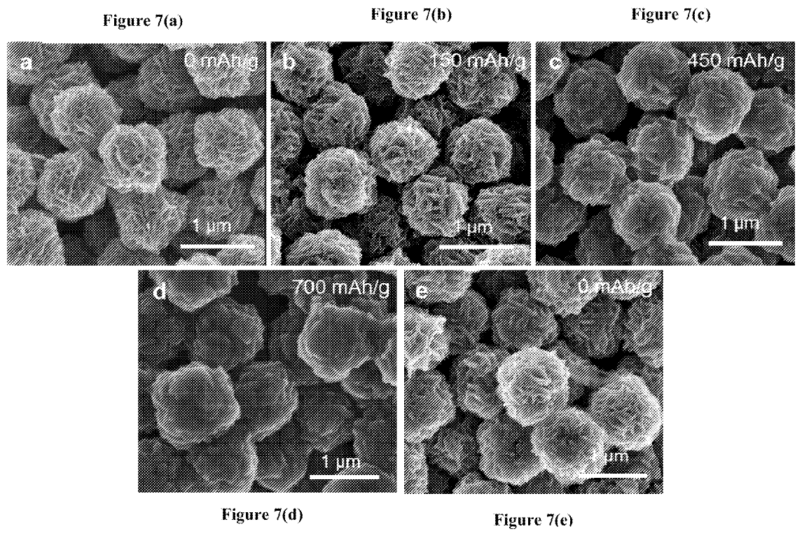

According to some aspects of embodiments, it was found that lithium could be uniformly plated on CF with commercial carbonate electrolytes. As seen in FIG. 2(a), no obvious lithium nucleation overpotential could be observed when we plate lithium on CF. The absence of nucleation overpotential, which is distinct from common 3D host materials, indicates that lithium might be uniformly plated on nanostructures of CF. This is further confirmed by the SEM imaging study. The cells are stopped at five stages (i-v) in a cycle to study the morphology evolution of CF particles during lithiation and delithiation as shown in FIG. 2(a). FIGS. 2(b) and 7(a) to 7(e) show the corresponding SEM images of the five points on the voltage profile, from lithiated CF to fully delithiated CF. As can be seen from FIGS. 2(b) and 7(a) to 7(e), the “petals” of CF were sharp and thin without lithiation as shown in FIG. 2b(i). Upon intercalation, the “petals” thickened slightly as shown in FIG. 2(b)(ii). More significant changes happened when the voltage went below 0 V (v.s. Li⁺/Li), and lithium plating started. The petal became significantly thicker, and the valleys between the intersecting “petals” started to be filled up as shown in FIG. 2(b)(iii). When the maximum allowed capacity is reached, the CF particle seemed to be totally filled and wrapped up with lithium as shown in FIG. 2(b)(iv). The original morphology of CF was restored once the delithiation process was completed as shown in FIG. 2(b)(v). The imaging of the morphology evolution process indicates that lithium metal was uniformly plated on the “petals” and the pores between them.

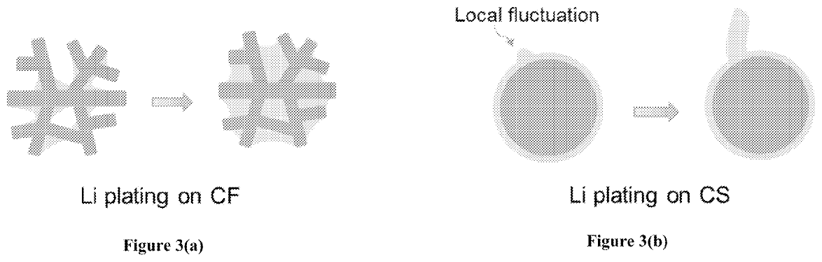

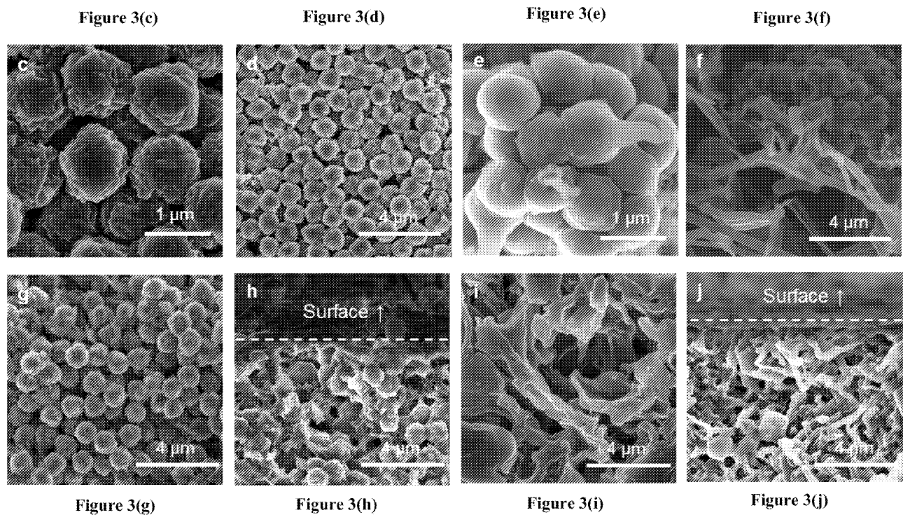

Distinctly different lithium deposition morphology was observed on CF and CS at the same specific capacity and current density (700 mAh/g, ˜4 mAh/cm², 2 mA/cm²). FIGS. 3(a) to 3(j) illustrate aspects of these observations. FIGS. 3(a) and 3(b) are schematics showing Li plating process on CF particles (a) and CS particles (b). FIGS. 3(c) and 3(d) are SEM images of CF plated with Li. FIGS. 3(e) and 3(f) are SEM images of CS plated with Li. FIG. 3(g) is a post-mortem SEM image of the surface of a CF electrode after 100 cycles. The electrode surface was rinsed with DEC solvent to remove rSEI. FIG. 3(h) is a post-mortem SEM image of the cross-section of a CF electrode after 100 cycles. The electrode was unrinsed to preserve the rSEI morphology. FIG. 3(i) is a post-mortem SEM image of the surface of a CS electrode after 100 cycles. The electrode surface was rinsed with DEC solvent to remove rSEI. FIG. 3(h) is a post-mortem SEM image of the cross-section of a CS electrode after 100 cycles. The electrode was unrinsed to preserve the rSEI morphology. Cycling conditions in FIGS. 3(c) to 3(f) are: 700 mAh/g, ˜4 mAh/cm², 2 mA/cm², first cycle without stripping. Cycling conditions in FIGS. 3(g) to 3(j) are: 700 mAh/g, ˜2.5 mAh/cm², charging current: 1-20 mA/cm², 1 mA/cm² increase every 5 cycles, discharging current: 1 mA/cm², fully stripped to 1.6 V at 100^{th} cycle. Electrolyte: LP57:FEC=10:1.

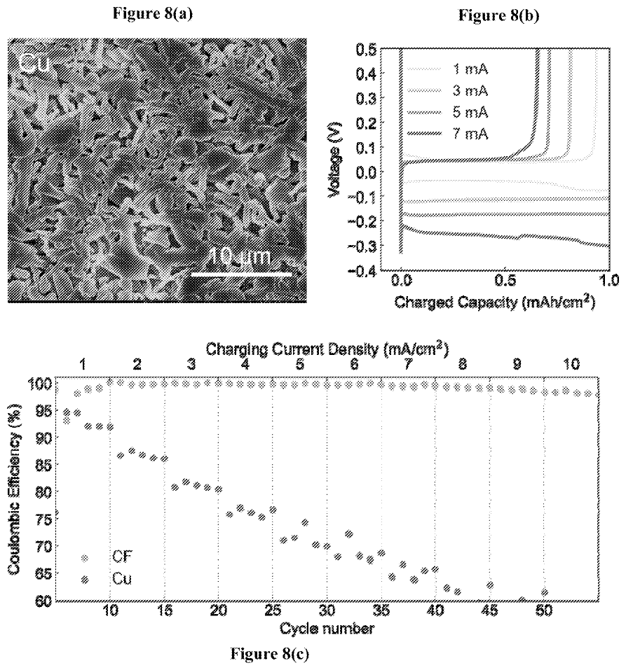

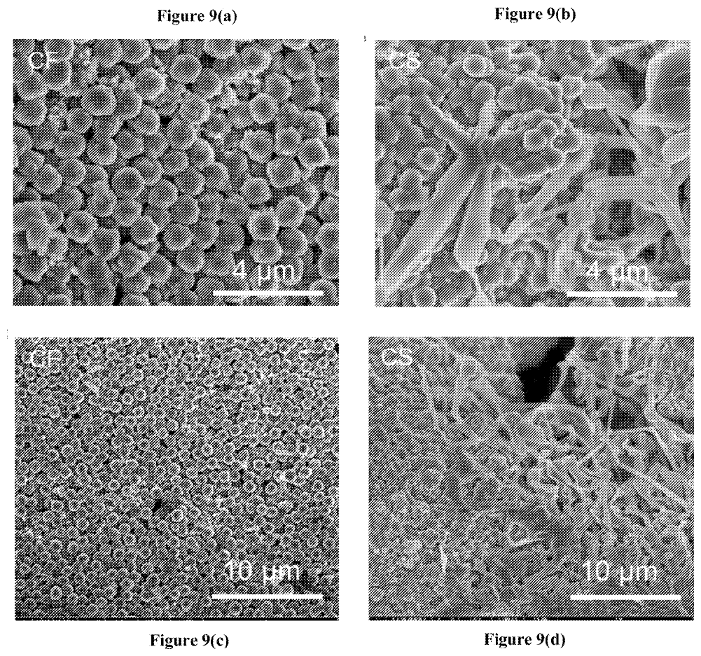

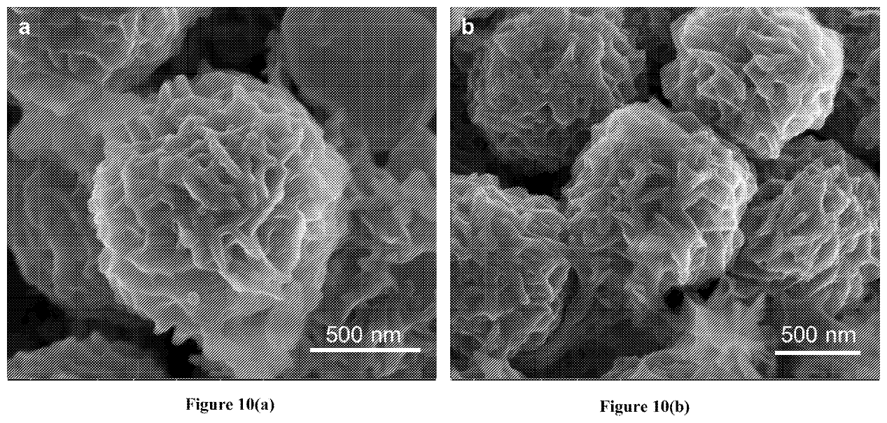

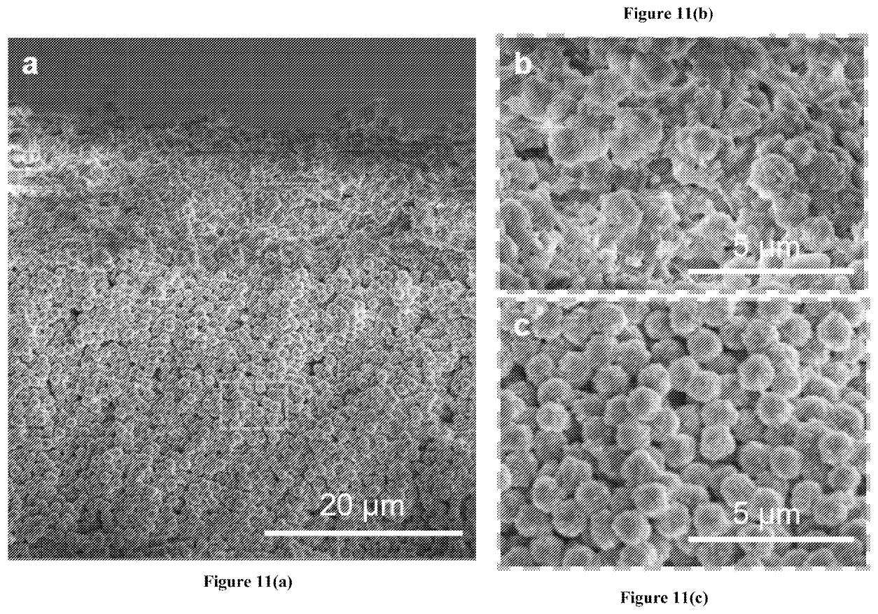

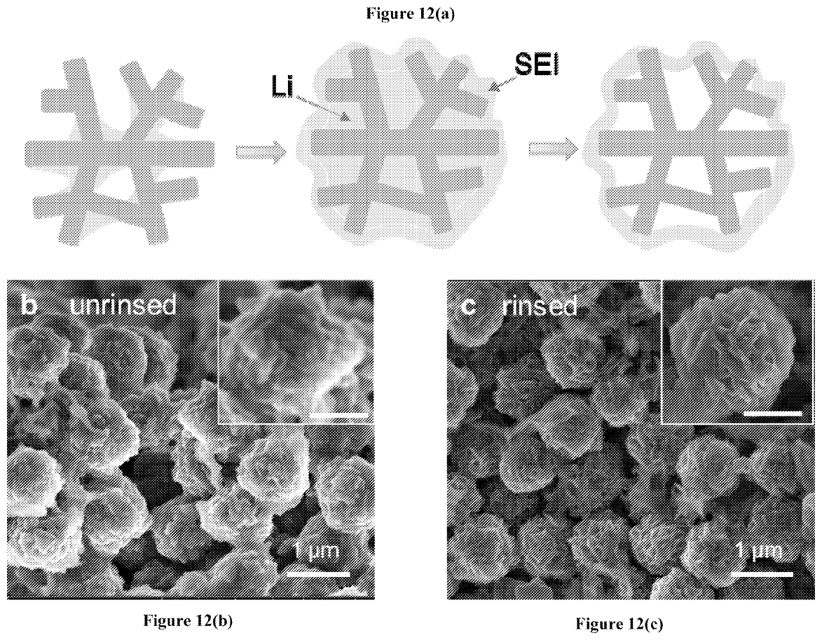

As can be seen from the figures, lithium filaments were observed to grow outwards the surface of CS particles at the end of the first deposition process (FIGS. 3(b), 3(e) and 3(f)), while the morphology of lithium is uniform on CF particles (FIGS. 3(a), 3(c) and 3(d)). Bare copper electrode surfaces was also observed to be covered with filaments as a comparison (FIG. 8(a)). At high current density (12 mA/cm²), CF electrodes still had uniform lithium morphology (FIGS. 9(a) and 9(c)), which is different than that of CS (FIGS. 9(b) and 9(d)). Moreover, post-mortem morphologies were observed to be significantly different on CF and CS electrodes after 100 cycles (lithium fully-stripped). FIGS. 3(g) and 3(i) show CF and CS electrodes' rinsed surface (to remove rSEI). CS electrode surface was covered by dead lithium filaments (FIG. 3(i)), while CF electrodes had no observable dead lithium on the surface (FIG. 3(g)). The zoom-in view of SEM images shows that CF nanostructures remain intact after cycling (FIGS. 10(a) and 10(b)). FIGS. 3(h) and 3(j) demonstrate the cross-section views of unrinsed CF and CS electrodes with the same cycling conditions (100 cycles, fully stripped). A thick layer of “dead lithium” filaments was observed on the CS electrode (FIG. 3(j)), while the CF electrode had no dead lithium layer. Meanwhile, there is also no observable thick rSEI layer on the CF electrodes (FIG. 3(h) and FIGS. 11(a) to 11(c)). Further imaging after rinsing indicated that the rSEI was mainly wrapped around individual CF particles (FIGS. 12(a) to 12(c)), which is indirect evidence that lithium metal was plated conformally around CF particles.

Three factors were attributed to the uniform lithium morphology on CF: lithium-ion intercalation, the effects of nanostructures, and the SEI structures. Firstly, lithium-ion intercalation prior to lithium metal plating could change the lithium wettability of the carbon surface. Graphite and hard carbon are known to be lithiophobic without surface modifications. Interestingly, they are super-lithiophilic when intercalated with lithium ions. (Duan, J.; Zheng, Y.; Luo, W.; Wu, W.; Wang, T.; Xie, Y.; Li, S.; Li, J.; Huang, Y. Is Graphite Lithiophobic or Lithiophilic? National Science Review 2020, 7 (7), 1208-1217. https://doi.org/10.1093/nsr/nwz222. Lithiophilic surfaces are commonly regarded as a beneficial property for lithium metal plating as they enable lithium to wet the surface uniformly rather than forming filaments. Therefore, lithium-ion intercalation rendered the surface of CF lithiophilic and minimized the nucleation barrier of lithium. Second, the nanostructures provide high surface area and large pore volume. As shown in FIG. 1(h), CF demonstrates ˜3 times BET surface area and ˜10 times pore volume compared to CS. Even though CS is lithiophilic after intercalation, it can only host limited lithium on the exterior surface of the particles due to a low surface area and a small pore volume. On the contrary, the higher surface area of CF minimized the local current density and maximized the available lithiophilic surfaces, while large pore volume provided enough space for the volume changes of lithium inside CF particles. Third, due to the confinement of lithium metal to the CF structure, minimal SEI damage and repair were required with the limited lithium volume change. This prevents the accumulation of rSEI fragments and non-uniform lithium deposition due to SEI defects.

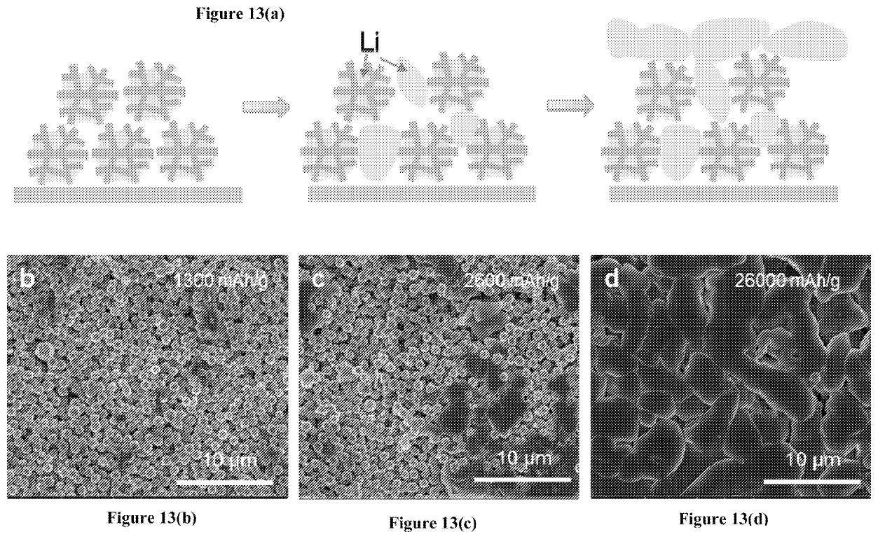

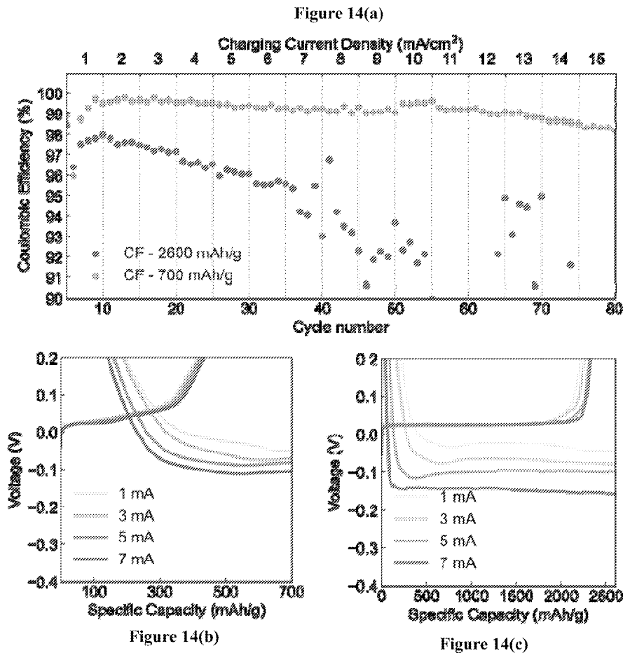

It is worth mentioning that if one further increases the lithiation capacity of CF to over 1000 mAh/g, nanostructures of CF had minimum effects on lithium plating behavior as they were already filled up. The excess lithium plated on the exterior surface of CF and started to fill the space between CF particles, as shown in FIGS. 13(a) to 13(d). In this case, nucleation overpotentials of lithium appeared in the voltage profile (FIG. 14(c)), and individual lithium chunks (not filaments, interestingly) were observed on the electrode (FIGS. 13(a) to 13(d)). The CE of those cells (>1000 mAh/g) is much lower compared to the ones with a controlled 700 mAh/g capacity (FIG. 14(a)). It suggests that confining lithium in the pores of CF nanostructures is essential to good cell performance.

### Example Electrochemical Performances

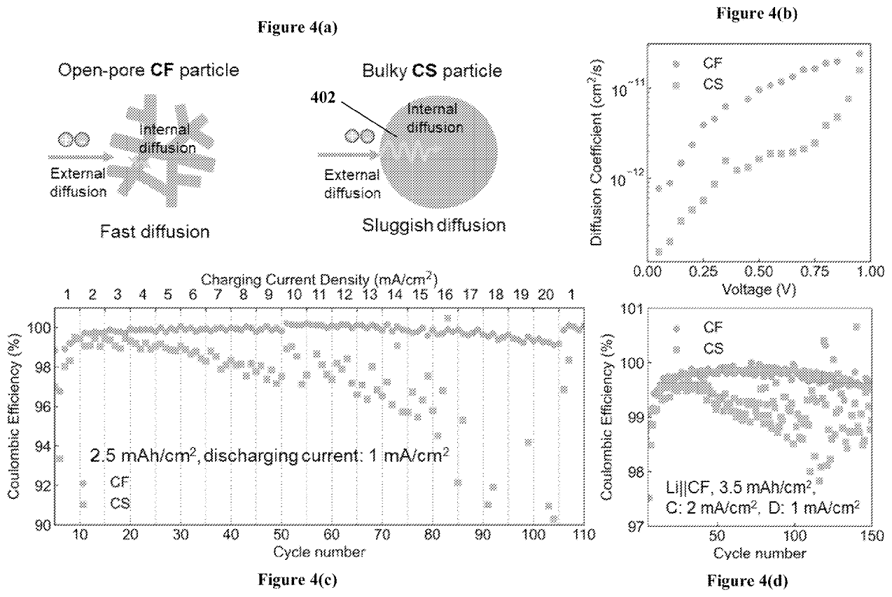

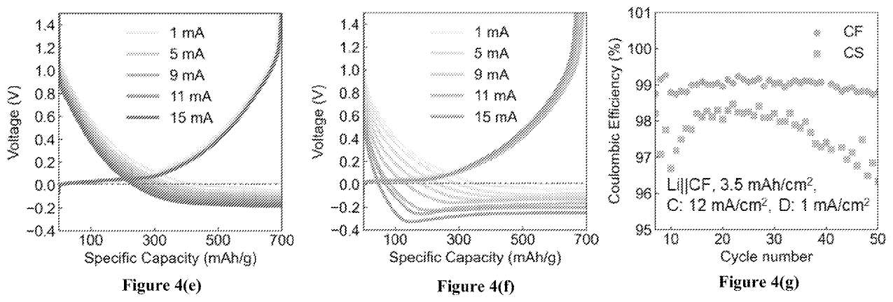

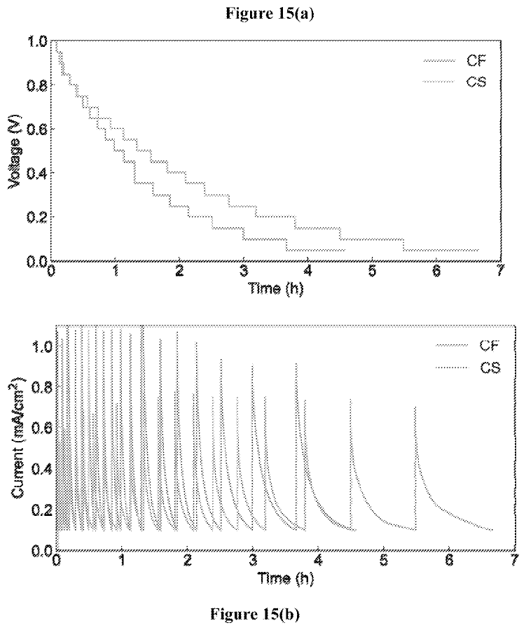

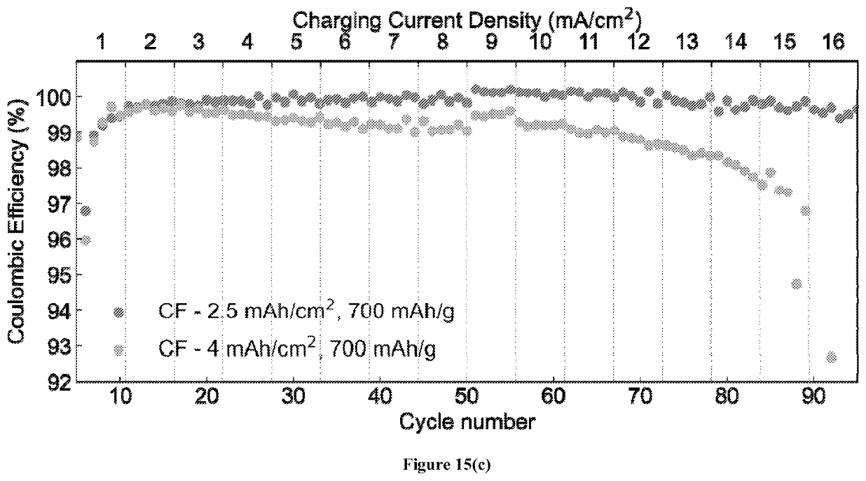

In addition to uniform lithium morphology, the present Applicant recognizes that the open-pore structures could provide faster ion diffusion pathways. The open-pore structures of CF endow it with much shorter ion-diffusion pathways compared to bulky CS particles, as illustrated by the line 402 in FIG. 4(a). It was consistent with a Li⁺ diffusion constant measurement by potentiostatic intermittent titration technique (PITT) (Kaspar, J.; Graczyk-Zajac, M.; Riedel, R. Determination of the Chemical Diffusion Coefficient of Li-Ions in Carbon-Rich Silicon Oxycarbide Anodes by Electro-Analytical Methods. Electrochimica Acta 2014, 115, 665-670. https://doi.org/10.1016/j.electacta.2013.10.184; Levi, M. D.; Aurbach, D. Diffusion Coefficients of Lithium Ions during Intercalation into Graphite Derived from the Simultaneous Measurements and Modeling of Electrochemical Impedance and Potentiostatic Intermittent Titration Characteristics of Thin Graphite Electrodes. J. Phys. Chem. B 1997, 101 (23), 4641-4647. https://doi.org/10.1021/jp9701911; Levi, M. D.; Levi, E. A.; Aurbach, D. The Mechanism of Lithium Intercalation in Graphite Film Electrodes in Aprotic Media. Part 2. Potentiostatic Intermittent Titration and in Situ XRD Studies of the Solid-State Ionic Diffusion. Journal of Electroanalytical Chemistry 1997, 421 (1-2), 89-97. https://doi.org/10.1016/S0022-0728(96)04833-4.) (FIGS. 4(b) and 15(a) to 15(c)). CF showed almost an order of magnitude higher Li⁺ diffusion constant compared to CS at lithium-ion intercalation voltage window (0-1 V v.s. Li/Li⁺). Therefore, the open-pore structures of CF were expected to be advantageous for fast charging scenario. As a demonstration, performed were battery cycling tests in half cells. The mass loadings and specific capacities of CF and CS are controlled to be the same. Lithium foils were used as counter electrodes, and commercial carbonate electrolyte LP57/FEC (LP57:FEC=10:1) was used.

FIGS. 4(a) to 4(g) illustrate example aspects of these studies. FIG. 4(a) is a schematic showing the ion diffusion pathways in CF and CS. FIG. 4(b) illustrates Lithium-ion diffusion coefficient of CF and CS measured by PITT. FIG. 4(c) illustrates rate performance of Li∥CF and Li∥CS cells. FIG. 4(d) illustrates constant current cycling performance of Li∥CF and Li∥CS cells at 2 mA/cm². FIG. 4(e) provides voltage profiles of Li∥CF cells at different current densities. FIG. 4(f) provides voltage profiles of Li∥CS cells at different current densities. FIG. 4(g) illustrates constant current cycling performance of Li∥CF and Li∥CS cells at 12 mA/cm². Cycling conditions in FIGS. 4(c), 4(e) and 4(f): 700 mAh/g, ˜2.5 mAh/cm², the charging current began at 1 mA/cm² and was ramped up 1 mA/cm² every 5 cycles till it reached 20 mA/cm², discharging current: 1 mA/cm². Conditions in FIG. 4(d): 700 mAh/g, ˜3.5 mAh/cm², 2 mA/cm². Conditions in FIG. 4(g): 700 mAh/g, ˜3.5 mAh/cm², 12 mA/cm². Electrolyte: LP57:FEC=10:1.

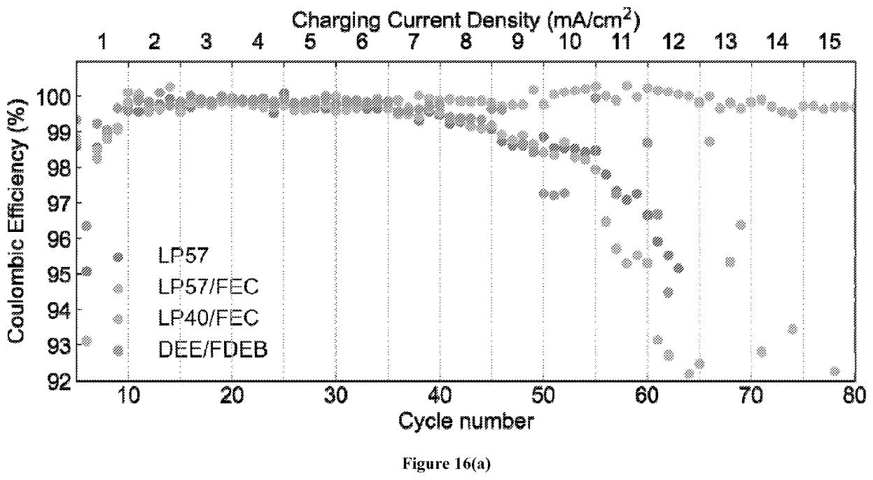

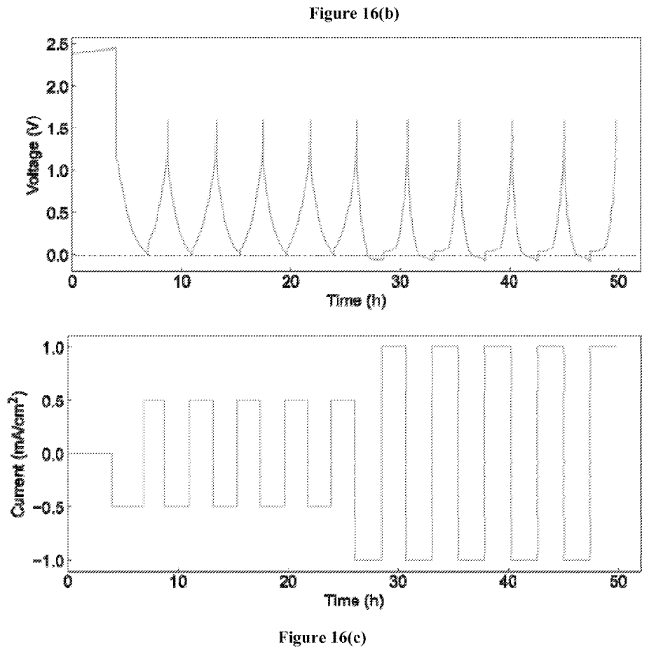

As shown in the figures, first studied was the CE at different current densities. Incremental current densities (1-20 mA/cm², 1 mA/cm² step every 5 cycles) were applied during charging (lithiation) and the discharging (delithiation) currents were controlled to be 1 mA/cm² (FIG. 4(c)). Li∥CF cells (˜2.5 mAh/cm², ˜3.5 mg/cm² CF, ˜700 mAh/g) showed high CE (>99.5%) with carbonate electrolyte LP57/FEC. Such high CE could be maintained up to −16 mA/cm², above which a slight decrease in CE was observed. In addition, the cells could go back to their original high CE when the charging current decreased from 20 to 1 mA/cm² (FIG. 4(c)). When thicker CF electrodes were used (˜4 mAh/cm², ˜5.7 mg/cm² CF, ˜700 mAh/g), >99% CE was observed up to ˜12 mA/cm² (FIGS. 15(a) to 15(c)). The same tests were also performed in several different electrolytes, which showed pronounced CE drops around ˜9 mA/cm² (FIGS. 16(a) to 16(c)). The high-rate performance was likely limited by the stability and ionic conductivity of the electrolytes, indicating electrolyte design is important in achieving stable cycling at high current densities. Meanwhile, CS also showed high CE at low current densities (FIG. 4(c)). However, the CEs dropped quickly with increased charging currents, and the cells shorted at ˜16 mA/cm². FIGS. 4(e) and 4(f) are voltage profiles corresponding to FIG. 4(c). CF has no observable nucleation overpotential at different current densities. Meanwhile, the intercalation capacity at >0V vs. Li/Li⁺ decreased slowly from 428 to 231 mAh/g when the charging current ramped up from 1 to 15 mA/cm² (FIG. 4(e) and Table 1). On the contrary, CS showed obvious nucleation overpotential peaks at high current densities. The intercalation capacity of CS at >0V v.s. Li/Li⁺ also decayed from 377 to 43 mAh/g (FIG. 4(f) and Table 1). Also tested was the rate performance of bare copper electrode. Large nucleation overpotentials were observed on copper electrode even at low current densities (FIG. 8(b)). The CE of Li∥Cu cells dropped quickly with increasing current densities (FIG. 8(c)).

FIGS. 4(d) and 4(g) show constant-current cycling of Li∥CF and Li∥CS cells at two charging current, 2 mA/cm² and 12 mA/cm² respectively. The areal loading was ˜3.5 mAh/cm² (˜5 mg/cm² CF), and discharging current was controlled to be 1 mA/cm². CF and CS both showed high CE (>99%) at the beginning when the charging current is 2 mA/cm². However, the CE of CS decayed rapidly over cycle number. It is likely due to the filaments deposition and dead lithium accumulation shown earlier. At high current densities (12 mA/cm²), CF still maintained ˜99% CE, while the CE of CS quickly dropped to <97%.

TABLE 1
Comparison of Intercalation Capacities and Overpotentials between CF and CS

| | Intercalation | | Lithium plating | | Overpotential at | | Nucleation | |
|---|---|---|---|---|---|---|---|---|
| Current | Capacity (mAh/g) | | Capacity (mAh/g) | | 700 mAh/g (mV) | | Overpotential (mV) | |
| (mA/cm²) | CF | CS | CF | CS | CF | CS | CF | CS |
| 1 | 428 | 377 | 272 | 323 | 54 | 51 | 0 | 2 |
| 3 | 361 | 285 | 339 | 415 | 73 | 76 | 0 | 20 |
| 5 | 327 | 225 | 373 | 475 | 91 | 95 | 0 | 24 |
| 7 | 305 | 170 | 395 | 530 | 111 | 113 | 0 | 28 |
| 9 | 285 | 131 | 415 | 569 | 130 | 137 | 0 | 32 |
| 11 | 261 | 88 | 439 | 612 | 151 | 164 | 0 | 57 |
| 13 | 246 | 60 | 454 | 640 | 169 | 207 | 0 | 77 |
| 15 | 231 | 43 | 469 | 657 | 185 | 253 | 2 | 86 |

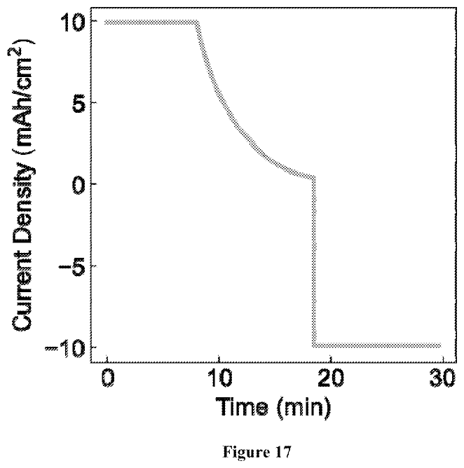

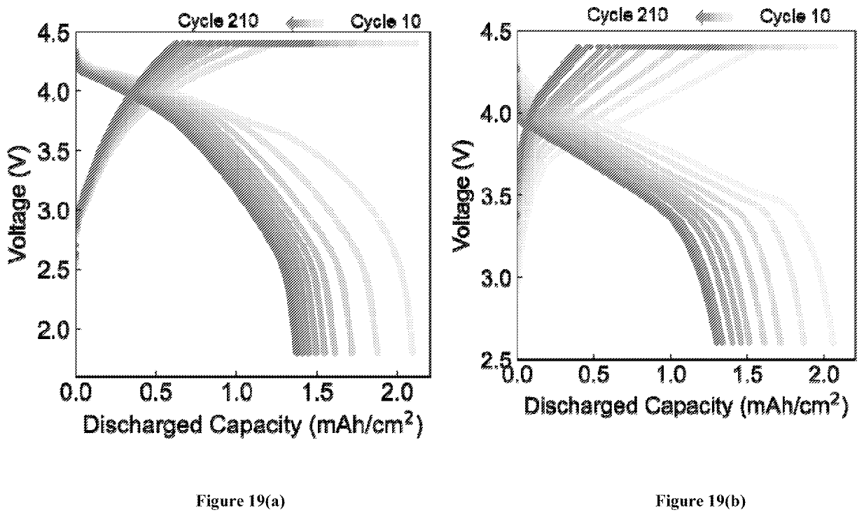

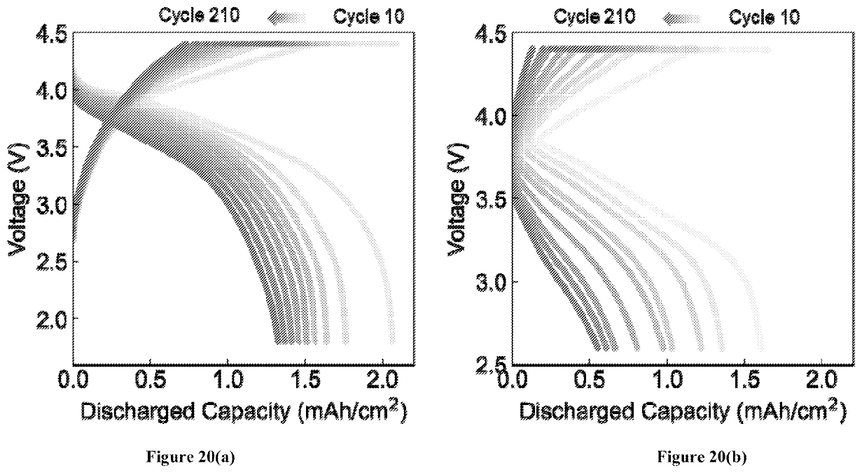

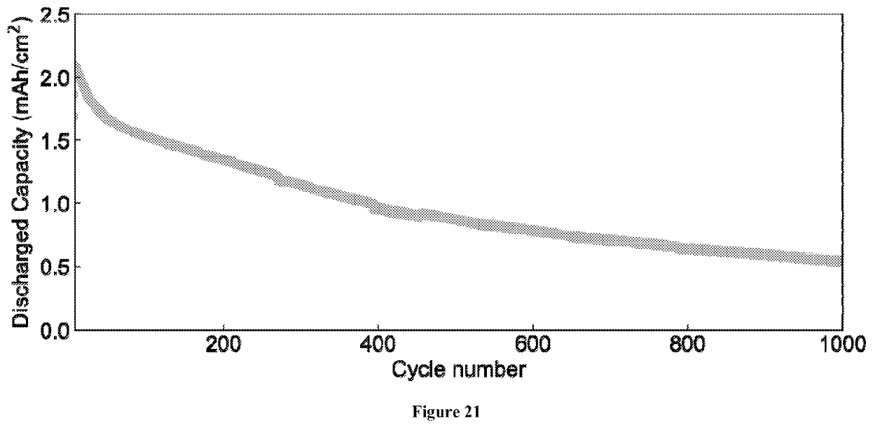

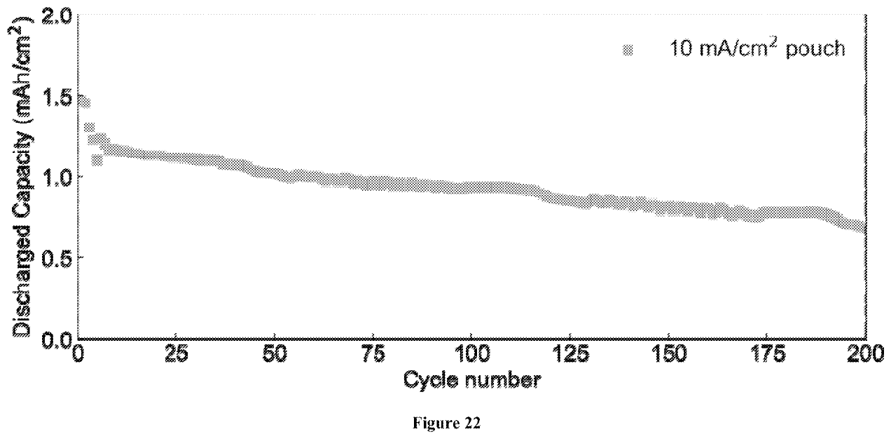

To demonstrate more realistic cycling conditions, tested were the cell performances of CF electrodes (˜3.5 mg/cm²) paired with commercial NMC811 (˜2mAh/cm²) electrodes. CF electrodes were pre-cycled in Li∥CF cells for 10 cycles and fully delithiated to passivate the surface (FIGS. 16(a) to 16(c)) due to the low initial CF of hard carbon. Commercial graphite (Gr) electrodes (7.44 mg/cm²) were used as comparison to CF electrodes. It is worth noting that the graphite electrode was designed to have a specific capacity of ˜320 mAh/g and was operated in the lithium-ion mode for the chosen cathode loading (˜2 mAh/cm²) CF∥NMC811 and Gr∥NMC811 cells were cycled at different current densities with commercial carbonate electrolyte (LP57: FEC=10:1). For the charging process of all cells (FIGS. 17 to 22), a constant current charging was applied till 4.4V, followed by a constant voltage hold at 4.4V (till current <0.4 mA/cm²). All cells were discharged to <1.8V (CF∥NMC811) and <2.6 V (Gr∥NMC811) with a constant current.

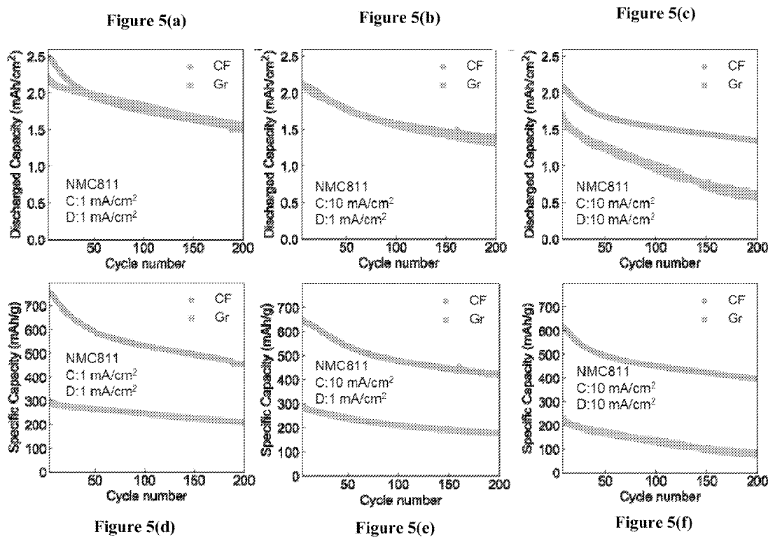

FIGS. 5(a) to 5(f) illustrate example aspects of full cell performances of CF∥NMC811 and Gr∥NMC811 cells. Cycling conditions: NMC811: ˜2 mAh/cm², CF loading: 3.5 mg/cm², Gr loading: ˜7.44 mg/cm², 100% SOC, all cells are charged to 4.4V and hold at 4.4V until the current dropped below 0.4 mA/cm². FIG. 5(a) illustrates discharged capacity at 1 mA/cm² charging current and 1 mA/cm² discharging current. FIG. 5(b) illustrates discharged capacity at 10 mA/cm² charging current and 1 mA/cm² discharging current. FIG. 5(c) illustrates discharged capacity at 10 mA/cm² charging current and 10 mA/cm² discharging current. FIG. 5(d) illustrates specific capacity of anode materials at 1 mA/cm² charging current and 1 mA/cm² discharging current. FIG. 5(e) illustrates specific capacity of anode materials at 10 mA/cm² charging current and 1 mA/cm² discharging current. FIG. 5(f) illustrates specific capacity of anode materials at 10 mA/cm² charging current and 10 mA/cm² discharging current. Electrolyte: LP57:FEC=10:1.

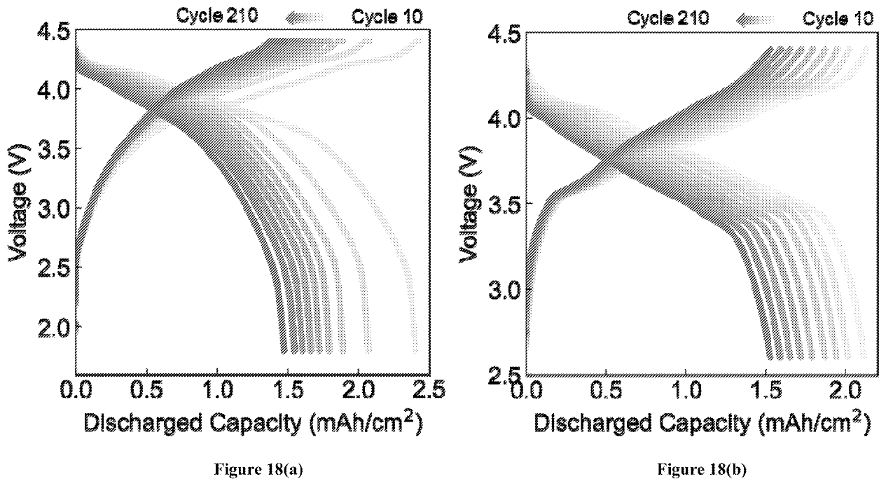

As can be seen from the figures, at relatively low current densities (charging: 1 mA/cm², discharging: 1 mA/m²), Gr∥NMC811 cells showed better capacity retention compared to CF∥NMC811 cells (FIG. 5(a)). However, CF electrodes had a much higher specific capacity compared to Gr due to the contribution from lithium metal plating (FIG. 5(d)). Despite the lower capacity retention, CF electrodes still showed ˜2x specific capacity compared to Gr electrodes during the first 200 cycles. In addition, the stack specific energy of CF∥NMC811 was estimated to be 25% higher than that of Gr∥NMC811 (Table Si). When 10 mA/cm² charging and 1 mA/cm² discharging current were applied, Gr∥NMC811 showed a drop in the capacity retention (FIG. 5(b)) while CF∥NMC811 had similar cyclic stability compared to the low-current case. Again, CF had ˜2x specific capacity compared to Gr due to the contribution from lithium metal plating (FIG. 5(e)). Notably, this is a rare demonstration of stable lithium-metal-containing anode under fast charging and slow discharging conditions. When both charging and discharging currents are 10 mA/cm², Gr∥NMC811 electrode showed fast capacity decay, with only ˜30% capacity available after 200 cycles. CF maintained stable cycling at fast-charging and fast-discharging scenarios with ˜70% capacity available after 200 cycles. The CF∥NMC811 cells could be charged to 100% SOC in <20 min at 10 mA/cm² high charging current (FIG. 17). Meanwhile, the specific capacity of CF is as ˜4× as high as that of Gr (FIG. 5(f)). The cost of CF anodes could be lower than graphite since they need only ˜25% weight of material to achieve the same capacity. In addition, the hybrid cells did not suddenly die due to an internal shorting like LMBs. The capacity gradually dropped over cycles, and the cells finally turned into lithium-ion cells when they lost all overbalanced lithium metal capacity. These cells could reach >1000 cycles without shorting (FIGS. 18(a) and 18(b)), indicating those hybrid cells are safer compared to pure LMBs. These results showed CF is an excellent candidate for fast charging applications.

### CONCLUSION

In summary, the present embodiments introduce an open-pore flower-like hard carbon (CF) to enable fast charging hybrid anode chemistry with commercial carbonate electrolyte. Metallic lithium was plated on the hard carbon particles to form a hybrid lithium-ion/lithium-metal anode. It is shown that the unique nanostructure rendered uniform and conformal lithium metal plating within the CF particles. In addition, the open-pore structure of CF provided fast-ion diffusion pathways compared to spherical particles, which endowed them with excellent cyclic stability at high current densities. As a result, the CF anodes demonstrated >99.5% CE up to 16 mA/cm² (2 mAh/cm², 700 mAh/g) and >99% CE up to 12 mA/cm² (4 mAh/cm², 700 mAh/g) in Li∥CF half-cell with commercial LP57 electrolyte and FEC. CF∥NMC811 hybrid cells showed much better cyclic stability and >2× anode specific capacity compared to graphite∥NMC811 lithium-ion cells at high current densities during realistic cycling conditions. Specifically, the CF∥NMC811 hybrid cells (2 mAh, 100% SOC) showed superior performance (˜70% capacity retention for 200 cycles) at high current densities (10 mA/cm² charge, 1 or 10 mA/cm² discharging current). Considering the scalability of CF, it would be a promising candidate for near-future fast-charging applications. Moreover, the results showed that a combination of lithium-ion intercalation and nanostructure design could largely improve the stability of lithium metal anode chemistry under high current densities, which is an important insight for the development of fast-charging lithium metal anode.

### Example Chemicals and Materials

Acrylonitrile (≥99%, contains 35-45 ppm monomethyl ether hydroquinone as inhibitor), commercial polyacrylonitrile (average Mw 150,000) and 2,2′-Azobis(2-methylpropionitrile) (AIBN, 98%) was purchased from Sigma-Aldrich. Acetone and tetrahydrofuran (THE) (ACS, 99.5+%) were purchased from Thermo Scientific. 2,2,3,3-tetrafluoro-1,4-butanediol was purchased from Synquest. Sodium hydride (2.5 eqv., 60% in paraffin) was purchased from TCL Commercial carbonate electrolytes LP40 and LP57 were purchased from Gotion. 1,2-diethoxyethane (DEE) was purchased from Fisher. LiFSI was purchased from Arkema. Celgard 3501 separator (25 μm) was purchased from Celgard and used in all cells. Cu current collector (25 m) was purchased from Alfa Aesar. Graphite (˜2.4 mAh/cm²) and NMC811 (˜2 mAh/cm²) electrode sheets were purchased from Targray. Conductive carbon black C65, 2032-type coin cell cases, springs and spacers were purchased from MTI.

### Example Synthesis of FDEB

A solution of 2,2,3,3-tetrafluoro-1,4-butanediol (1 eqv.) in THF was cooled in an ice bath, to which sodium hydride (2.5 eqv., 60% in paraffin) was added slowly under vigorous stirring. After H₂ bubbling stopped, ethyl p-toluenesulfonate (2.2 eqv.) was added in one portion, and the reaction mixture was stirred at room temperature for 3 hours, followed by heating at 60° C. overnight. The reaction mixture was filtered and THF was removed by the rotary evaporator. The crude product was purified by vacuum distillation for three times, with the second and third time over sodium hydride to remove water.

### Example Synthesis of CF and CS

Synthesis of CF can be performed in many different ways. Typically, 5 mL acrylonitrile, 5 mL acetone and 5 mg AIBN were mixed and purged with N₂. Then, the solution was heated up to 70° C. to polymerize under N₂ protection. After an overnight reaction, the polyacrylonitrile (PAN) product was dried with vacuum and ground to powders. The dried powders were later heated to 230° C. for 2 hours under air to stabilize the PAN structures. Next, the stabilized PAN powders were heated up to >1000° C. in N₂ atmosphere for 2 hours to carbonize and form CF powders. The synthesis process of CS is the same as CF except the stabilization process was conducted in N₂ atmosphere.

### Example Characterizations

SEM images were collected by an FEI Magellan 400 XHR Scanning Electron Microscope at Stanford Nano Shared Facilities (SNSF). Raman spectroscopy was collected on a Horiba XploRA⁺ Confocal Raman Microscope at SNSF. XPS was collected on a PHI VersaProbe 3 XPS with an Al(Ka) radiation source (1486 eV). N₂ physisorption was conducted on Quantachrome Autosorb iQ3 with 99.999% N₂ at 77 K at SNSF. Pore size distribution was obtained using quenched solid-state density functional (QSDFT) calculations with the carbon model of slit pores.

### Example Electrode Preparation

Polyacrylic acid (PAA, M.W.=450,000) was dissolved in DI water and neutralized by adding a stoichiometric amount of LiOH according to a 1:1 mole ratio of LiOH to a monomeric unit of PAA). The solution was stirred overnight to form LiPAA solution (7 wt %). CF/CS powders, C65, and LiPAA, were mixed with the mass ratio of 85:5:10 to form slurries. The slurries were then blade-coated on a copper foil with controlled thickness. Next, the electrodes were dried at 80° C. for >48 hours and cut into dishes for coin cell assembly.

### Example Electrochemical Measurements

The 2032-type coin cells were used for electrochemical measurements. All coin cells were assembled in an Ar-filled glovebox and tested at room temperature on Arbin or Land testing stations. Celgard 3501 was used as the separator. 60 L electrolytes were used unless specified. Thick Li foils with fresh surfaces and 11 mm diameters were used to assemble Li∥CF and Li∥CS cells. For CE tests of Li∥CF and Li∥CS cells, all cells were first pre-cycled between 0-1.6 V for 5 cycles to passivate the carbon surfaces, and certain lithium capacities were deposited on CF or CS electrodes according to the areal mass loadings of CF or CS and certain specific capacity. Typically, ˜2.5 mAh/cm² of Li were deposited on a ˜3.5 mg/cm² CF or CS. The CE is calculated by dividing the total stripping capacity by the total deposition capacity. For rate tests of Li∥CF and Li∥CS cells, the applied current density started at 1 mA/cm² after 5 precycles (0-1.6V) and increased 1 mA/cm² every 5 cycles till it reached 20 mA/cm². Potentiostatic intermittent titration technique (PITT) was tested on Li∥CF and Li∥CS cells with the following procedure: (1) The cells were initially activated at 1 mA/cm² (0-1.6 V) for 1 cycle; (2) A 0.05 V stepwise potential drop was applied on the cells until the current dropped below 0.1 mA/cm². (3) Step (2) was repeated until the voltage dropped below 0.05 V. The lithium-ion diffusion coefficient was calculated following the equation:

$$D = [ ( \frac{\sqrt{π} \text{?} \sqrt{\text{?}}}{Δ \text{?}} ) ] \qquad ( 1 )$$

$$\text{?} \text{indicates text missing or illegible when filed}$$

Where D is the diffusion coefficient of lithium-ion. l is the radius of CF or CS particles. l\sqrt{c} is the Cottrell slope obtained from I v.s. 1\sqrt{c} data curves. ΔQ is the change of charge in each potential step. NMC811 (˜2 mAh/cm²) were used to assemble CF∥NMC811 and Gr∥NMC811 full cells. CF electrodes (˜3.5 mg/cm²) for full cells were first passivated with 10 pre-cycles in Li∥CF cells following the protocol: (1) 0-1.6V for 5 cycles; (2) ˜2.5 mAh/cm² lithium was deposited and stripped to 1.6 V for 5 cycles. All CF∥NMC811 full cells (2 mAh/cm², 1.8-4.4 V) began with the two formation cycles: 0.4 mA/cm² charging and 0.4 mA/cm² discharging for one cycle and 1 mA/cm² charging and 1 mA/cm² discharging for one cycle. Gr∥NMC811 full cells (2 mAh/cm², 2.6-4.4 V) began with the two formation cycles: 0.1 mA/cm² charging and 0.1 mA/cm² discharging for one cycle and 1 mA/cm² charging and 1 mA/cm² discharging for one cycle. After formation cycles, a constant-current-constant-voltage protocol was used for CF∥NMC811 and Gr∥NMC811 cycling at different rates: cells were charged to 4.4V and held at 4.4V until the current dropped below 0.4 mA/cm².

TABLE S1

| | Gr\|\|NMC811 | CF\|\|NMC811 |
|---|---|---|
| cathode loading (mg/cm²)^{a} | 10.74 | 10.74 |
| cathode active loading (mg/cm²)^{a} | 9.6 | 9.6 |
| anode loading (mg/cm²)^{a} | 8.26 | 4.12 |
| anode active loading (mg/cm²)^{a} | 7.44 | 3.5 |
| separator thickness (μm) | 15 | 15 |
| separator weight (mg/cm²) | 1.08 | 1.08 |
| Cu thickness (μm) | 8 | 8 |
| Cu weight (mg/cm²) | 7.168 | 7.168 |
| Al thickness (μm) | 13 | 13 |
| Al weight (mg/cm²) | 3.51 | 3.51 |
| areal discharge energy (mWh/cm²)^{b} | 8.876 | 9.279 |
| stack specific energy (Wh/kg) | 349 | 436 |

TABLE S2
Comparison of Li metal anode systems

| | Anode | Charging | | | |
|---|---|---|---|---|---|
| | Specific | Current | Areal | | |
| | Capacity | Density | Capacity | | |
| | (mAh/g) | (mA/cm²) | (mAh/cm²) | Electrolyte | Average CE |
| CF\|\|NMC811 | 700 | 10 | 2 | 1M LiPF₆, | 99.81% |
| (This work) | | | | EC/EMC | |
| | | | | 3:7, 10% FEC | |
| Graphite \|\| Li¹ | 744 | 0.15 | 1.5 | 1M LiPF₆, | 98.4% |
| | | | | EC/DEC | |
| | | | | 1:1 | |
| Graphite \|\| NMC532² | 500 | 0.5 | 2.5 | 1M LiDFOB + | 99.79% |
| | | | | 0.4M LiBF₄ | |
| | | | | FEC/DEC | |
| | | | | 1:2 | |
| Graphite \|\| Li³ | 460 | 0.23 | 2.2 | 1M LiPF₆, | 99.5% |
| | | | | EC/DEC | |
| | | | | 1:2 | |
| PMF-Li \|\| Li⁴ | N/A | 10 | 1 | 1M LiTFSI | 94.7% |
| | | | | DOL/DME | |
| | | | | 1:1, 2% LiNO₃ | |
| VGA \|\| Li⁵ | 3343 | 5 | 5 | 1M LiTFSI | 99.08% |
| | | | | DOL/DME | |
| | | | | 1:1, 1% LiNO₃ | |
| HGA \|\| Li⁵ | 2180 | 1 | 1 | 1M LiTFSI | 96.7% |
| | | | | DOL/DME | |
| | | | | 1:1, 1% LiNO₃ | |
| RGA \|\| Li⁵ | 2180 | 1 | 1 | 1M LiTFSI | 97.4% |
| | | | | DOL/DME | |
| | | | | 1:1, 1% LiNO₃ | |
| Carbon shell-Au | N/A | 0.5 | 1 | 1M LiPF₆, | 98% |
| NPs\|\|Li⁶ | | | | EC/DEC | |
| | | | | 1:1, 1% VC + | |
| | | | | 10% FEC | |
| NOCA \|\| Li⁷ | N/A | 4 | 2 | 1M LiPF₆, | 95% |
| | | | | EC/DMC | |
| | | | | 1:1 | |
| Li-CSMF \|\| Cu⁸ | ~800 | 10 | 0.5 | 1M LiTFSI | ~92% |
| | | | | DOL/DME | |
| | | | | 1:1, 1% LiNO₃ | |
| CNTs-MC \|\| Li⁹ | 1640 | 5 | 10 | 1M LiTFSI | 98.3% |
| | | | | DOL/DME | |
| | | | | 1:1, 2% LiNO₃ | |
| 3D LiNO₃ \|\| LFP¹⁰ | 920 | 0.5 | 1.2 | 1M LiPF₆, | 99.3% |
| | | | | EC/DMC | |
| | | | | 1:1 | |
| LAL \|\| Cu¹¹ | N/A | 1 | 1 | 1M LiTFSI | 97.4% |
| | | | | DOL/DME | |
| | | | | 1:1, 1% LiNO₃ | |
| Cu foam \|\| Li¹² | 13 | 3 | 1 | 1M LiTFSI | 94% |
| | | | | DOL/DME | |
| | | | | 1:1, LiNO₃ | |
| Cu \|\| NMC532¹³ | N/A | 0.6-0.8 | 3-4 | 1M LiFSI | 99.78% |
| | | | | FDMB | |
| Cu \|\| LFP¹⁴ | N/A | 2.1 | 2.1 | 1M LiFSI | 99.74% |
| | | | | F5DEE | |
| Li \|\| NMC811¹⁵ | 3860 | 0.8 | 4.8 | 1M LiFSI | 99.38% |
| | | | | DEE | |
| C/Si \|\| LCO (Li-ion)¹⁶ | 100 | 10.2 | 3.4 | 1.3M LiPF₆, | 99.55% |
| | | | | EC/EMC/DEC | |
| | | | | 3:5:2, 10% FEC, | |
| | | | | 0.2% LiBF₄, | |
| | | | | 0.5% VC, 3% | |
| | | | | Succinonitrile, | |
| | | | | 1% Propane | |
| | | | | Sultone | |
| Graphite \|\| NMC532 | 265 | 15 | 2.5 | 1M LiPF₆, | 99.97% |
| (Li-ion)¹⁷ | | | | EC/EMC | |
| | | | | 3:7, 2 wt % VC | |
| Graphite/hard carbon \|\| | 290 | 18 | 3 | 1M LiPF₆, | 99.96% |
| NMC532 (Li-ion)¹⁸ | | | | EC/EMC | |
| | | | | 3:7, 2 wt % VC | |

Supplementary References indicated with superscripts in the table above are as PGP-follows:
(1) Sun, Y.; Zheng, G.; Seh, Z. W.; Liu, N.; Wang, S.; Sun, J.; Lee, H. R.; Cui, Y. Graphite-Encapsulated Li-Metal Hybrid Anodes for High-Capacity Li Batteries. Chem 2016, 1 (2), 287-297. https://doi.org/10.1016/j.chempr.2016.07.009.
(2) Martin, C.; Genovese, M.; Louli, A. J.; Weber, R.; Dahn, J. R. Cycling Lithium Metal on Graphite to Form Hybrid Lithium-Ion/Lithium Metal Cells. Joule 2020, 4 (6), 1296-1310. https://doi.org/10.1016/j.joule.2020.04.003.
(3) Cai, W.; Yan, C.; Yao, Y.; Xu, L.; Chen, X.; Huang, J.; Zhang, Q. The Boundary of Lithium Plating in Graphite Electrode for Safe Lithium-Ion Batteries. Angew. Chem. Int. Ed. 2021, 60 (23), 13007-13012. https://doi.org/10.1002/anie.202102593.
(4) Fan, L.; Zhuang, H. L.; Zhang, W.; Fu, Y.; Liao, Z.; Lu, Y. Stable Lithium Electrodeposition at Ultra-High Current Densities Enabled by 3D PMF/Li Composite Anode. Adv. Energy Mater. 2018, 8 (15), 1703360. https://doi.org/10.1002/aenm.201703360.
(5) Chen, H.; Pei, A.; Wan, J.; Lin, D.; Vili, R.; Wang, H.; Mackanic, D.; Steinruck, H.-G.; Huang, W.; Li, Y.; Yang, A.; Xie, J.; Wu, Y.; Wang, H.; Cui, Y. Tortuosity Effects in Lithium-Metal Host Anodes. Joule 2020, 4 (4), 938-952. https://doi.org/10.1016/j.joule.2020.03.008.
(6) Yan, K.; Lu, Z.; Lee, H.-W.; Xiong, F.; Hsu, P.-C.; Li, Y.; Zhao, J.; Chu, S., Cui, Y. Selective Deposition and Stable Encapsulation of Lithium through Heterogeneous Seeded Growth. Nat Energy 2016, 1 (3), 16010. https://doi.org/10.1038/nenergy.2016.10.
(7) Xu, Z.; Xu, L.; Xu, Z.; Deng, Z.; Wang, X. N, O-Codoped Carbon Nanosheet Array Enabling Stable Lithium Metal Anode. Adv Funct Materials 2021, 31 (40), 2102354. https://doi.org/10.1002/adfm.202102354.
(8) Wang, Z. Y.; Lu, Z. X.; Guo, W.; Luo, Q.; Yin, Y. H.; Liu, X. B.; Li, Y. S.; Xia, B. Y.; Wu, Z. P. A Dendrite-Free Lithium/Carbon Nanotube Hybrid for Lithium-Metal Batteries. Adv. Mater. 2021, 33 (4), 2006702. https://doi.org/10.1002/adma.202006702.
(9) Xie, J.; Ye, J.; Pan, F.; Sun, X.; Ni, K.; Yuan, H.; Wang, X.; Shu, N.; Chen, C.; Zhu, Y. Incorporating Flexibility into Stiffness: Self-Grown Carbon Nanotubes in Melamine Sponges Enable A Lithium-Metal-Anode Capacity of 15 MA h Cm⁻² Cyclable at 15 MA Cm⁻². Adv. Mater. 2018, 1805654. https://doi.org/10.1002/adma.201805654.
(10) Liu, H.; Yue, X.; Xing, X.; Yan, Q.; Huang, J.; Petrova, V.; Zhou, H.; Liu, P. A Scalable 3D Lithium Metal Anode. Energy Storage Materials 2019, 16, 505-511. https://doi.org/10.1016/j.ensm.2018.09.021.
(11) Ye, L.; Liao, M.; Cheng, X.; Zhou, X.; Zhao, Y.; Yang, Y.; Tang, C.; Sun, H.; Gao, Y.; Wang, B.; Peng, H. Lithium-Metal Anodes Working at 60 MA Cm⁻² and 60 MAh Cm⁻² through Nanoscale Lithium-Ion Adsorbing. Angew. Chem. Int. Ed. 2021, 60 (32), 17419-17425. https://doi.org/10.1002/anie.202106047.
(12) Ke, X.; Cheng, Y.; Liu, J.; Liu, L.; Wang, N.; Liu, J.; Zhi, C.; Shi, Z.; Guo, Z. Hierarchically Bicontinuous Porous Copper as Advanced 3D Skeleton for Stable Lithium Storage. ACS Appl. Mater. Interfaces 2018, 10 (16), 13552-13561. https://doi.org/10.1021/acsami.8b01978.
(13) Yu, Z.; Wang, H.; Kong, X.; Huang, W.; Tsao, Y.; Mackanic, D. G.; Wang, K.; Wang, X.; Huang, W.; Choudhury, S.; Zheng, Y.; Amanchukwu, C. V.; Hung, S. T.; Ma, Y.; Lomeli, E. G.; Qin, J.; Cui, Y.; Bao, Z. Molecular Design for Electrolyte Solvents Enabling Energy-Dense and Long-Cycling Lithium Metal Batteries. Nat Energy 2020, 5 (7), 526-533. https://doi.org/10.1038/s41560-020-0634-5.
(14) Yu, Z.; Rudnicki, P. E.; Zhang, Z.; Huang, Z.; Celik, H.; Oyakhire, S. T.; Chen, Y.; Kong, X.; Kim, S. C.; Xiao, X.; Wang, H.; Zheng, Y.; Kamat, G. A.; Kim, M. S.; Bent, S. F.; Qin, J.; Cui, Y.; Bao, Z. Rational Solvent Molecule Tuning for High-Performance Lithium Metal Battery Electrolytes. Nat Energy 2022, 7 (1), 94-106. https://doi.org/10.1038/s41560-021-00962-y.
(15) Chen, Y.; Yu, Z.; Rudnicki, P.; Gong, H.; Huang, Z.; Kim, S. C.; Lai, J.-C.; Kong, X.; Qin, J.; Cui, Y.; Bao, Z. Steric Effect Tuned Ion Solvation Enabling Stable Cycling of High-Voltage Lithium Metal Battery. J. Am. Chem. Soc. 2021, 143 (44), 18703-18713. https://doi.org/10.1021/jacs.1c09006.
(16) Kim, N.; Chae, S.; Ma, J.; Ko, M.; Cho, J. Fast-Charging High-Energy Lithium-Ion Batteries via Implantation of Amorphous Silicon Nanolayer in Edge-Plane Activated Graphite Anodes. Nat Commun 2017, 8 (1), 812. https://doi.org/10.1038/s41467-017-00973-y.
(17) Chen, K.-H.; Namkoong, M. J.; Goel, V.; Yang, C.; Kazemiabnavi, S.; Mortuza, S. M.; Kazyak, E.; Mazumder, J.; Thornton, K.; Sakamoto, J.; Dasgupta, N. P. Efficient Fast-Charging of Lithium-Ion Batteries Enabled by Laser-Patterned Three-Dimensional Graphite Anode Architectures. Journal of Power Sources 2020, 471, 228475. https://doi.org/10.1016/j.jpowsour.2020.228475.

(18) Chen, K.; Goel, V.; Namkoong, M. J.; Wied, M.; Müller, S.; Wood, V.; Sakamoto, J.; Thornton, K.; Dasgupta, N. P. Enabling 6C Fast Charging of Li-Ion Batteries with Graphite/Hard Carbon Hybrid Anodes. Adv. Energy Mater. 2021, 11 (5), 2003336. https://doi.org/10.1002/aenm.202003336.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

1. A method for operating a lithium metal battery (LMB), comprising:
cycling metallic lithium under high current densities and realistic cell conditions based on a flower-like nanostructured hard carbon host (CF),
wherein the CF is both intercalated with lithium ions and plated with lithium metal to form a hybrid lithium-ion/lithium-metal anode.

2. The method of claim 1, further comprising pairing the anode with commercial carbonate electrodes to obtain a cell.

3. The method of claim 2, wherein the commercial carbonate electrolytes include fluoroethylene carbonate additives.

4. The method of claim 2, wherein pairing is performed without adding extra lithium on the anode.

5. The method of claim 1, further comprising mixing CF powders, conductive carbon black, and binder to fabricate the anode.

6. The method of claim 5, further comprising coating the mixture on copper foil.

7. The method of claim 6, further comprising using lithium foils as counter electrodes.

8. A method of obtaining a lithium metal battery (LMB), comprising:
preparing an anode by synthesizing a flower-like nanostructured hard carbon host (CF);
intercalating the CF with lithium ions; and
plating the CF with lithium metal.

9. The method of claim 8, wherein synthesizing includes
mixing acrylonitrile, acetone and AIBN and purging with N₂;
heating the solution to polymerize under N₂ protection; and
drying the polyacrylonitrile (PAN) product with vacuum and grinding to powders.

10. The method of claim 9, further comprising:
heating the dried powders to stabilize the PAN structures; and
heating the stabilized PAN powders in N₂ atmosphere to carbonize and form CF powders.

11. The method of claim 9, wherein the acrylonitrile contains 35-45 ppm monomethyl ether hydroquinone as inhibitor.

12. The method of f claim 8, further comprising pairing the anode with a commercial carbonate electrode to obtain a cell.

13. The method of claim 12, further comprising preparing the electrode by:
dissolving polyacrylic acid in DI water and neutralizing by adding a stoichiometric amount of LiOH according to a 1:1 mole ratio of LiOH to a monomeric unit of PAA;
stirring the mixture to form a LiPAA solution;
mixing the CF, C65, and the LiPAA to form a slurry; and
blade-coating the slurry on a copper foil with controlled thickness.

14. The method of claim 13, wherein the CF is obtained by the method of claim 10.
